(19) United States
(12) Patent Application Publication
(10) Pub. No.: US 2025/0225772 A1
(43) Pub. Date: Jul. 10, 2025

(54) MODEL TRAINING METHOD FOR AUDIO/VIDEO MATCHING, ELECTRONIC DEVICE, AND STORAGE MEDIUM

(71) Applicant: TENCENT TECHNOLOGY (SHENZHEN) COMPANY LIMITED, Shenzhen (CN)

(72) Inventor: Yunxuan ZHANG, Shenzhen (CN)

(21) Appl. No.: 19/092,475

(22) Filed: Mar. 27, 2025

Related U.S. Application Data
(63) Continuation of application No. PCT/CN2023/131206, filed on Nov. 13, 2023.

(30) Foreign Application Priority Data
Feb. 28, 2023 (CN) 202310230025.X

(51) Int. Cl. G06V 10/77; G06V 10/62; G06V 10/764; G06V 10/776; G06V 10/82; G06V 20/40

(52) U.S. Cl. CPC G06V 10/7715; G06V 10/764; G06V 10/776; G06V 20/46; G06V 10/62; G06V 10/82

(57) ABSTRACT

A model training method includes: constructing a set of sample pairs based on at least one video sample and at least one audio sample, the set of sample pairs including at least one positive sample pair including a video sample and an audio sample that have a matching relationship and at least one negative sample pair including a video sample and an audio sample that do not have a matching relationship; extracting video feature information corresponding to the video sample through a video feature extraction model, and extracting audio feature information corresponding to the audio sample through an audio feature extraction model; determining a value of a contrastive loss function based on the video feature information and the audio feature information in the same sample pair; and adjusting parameters of the video feature extraction model and the audio feature extraction model based on the value of the contrastive loss function.

### CROSS-REFERENCES TO RELATED APPLICATIONS

This application is a continuation application of PCT Patent Application No. PCT/CN2023/131206, filed on Nov. 13, 2023, which claims priority to Chinese Patent Application No. 202310230025X, filed on Feb. 28, 2023, all of which is incorporated by reference in their entirety.

### FIELD OF THE TECHNOLOGY

Embodiments of the present disclosure relate to the field of artificial intelligence technologies and, in particular, to a model training method for audio/video matching, an audio/video matching method, electronic device, and storage medium.

### BACKGROUND OF THE DISCLOSURE

When using video software such as short videos, a user account may edit and post a video with background music added to the video. Often, background music is recommended for a video of a user account based on popularity of the background music (the number of times the background music has been used/played). For example, the background music is recommended for the user account in descending order of the number of times the audio of background music has been played.

However, recommendation of the background music to a user based on popularity is likely to result in mismatch between the recommended background music and content of the video to be posted, leading to a low hit rate (a ratio of a quantity of posted videos using background music from the recommended background music to a quantity of posted videos with background music) of the recommended background music.

### SUMMARY

One embodiment of the present disclosure includes a model training method for audio/video matching, performed by a computer device. The method includes constructing a set of sample pairs based on at least one video sample and at least one audio sample, the set of sample pairs including at least one positive sample pair and at least one negative sample pair, the positive sample pair including a video sample and an audio sample that have a matching relationship, and the negative sample pair including a video sample and an audio sample that do not have a matching relationship; for a video sample and an audio sample in a same sample pair, extracting video feature information corresponding to the video sample through a video feature extraction model, and extracting audio feature information corresponding to the audio sample through an audio feature extraction model; determining a value of a contrastive loss function based on the video feature information and the audio feature information in the same sample pair, the contrastive loss function being configured for representing a degree of matching of the sample pair; and adjusting parameters of the video feature extraction model and the audio feature extraction model based on the value of the contrastive loss function, to obtain a trained video feature extraction model and a trained audio feature extraction model.

Another embodiment of the present disclosure includes computer device. The computer device includes one or more processors and a memory containing computer-readable instructions that, when being executed, cause the one or more processors to perform: constructing a set of sample pairs based on at least one video sample and at least one audio sample, the set of sample pairs including at least one positive sample pair and at least one negative sample pair, the positive sample pair including a video sample and an audio sample that have a matching relationship, and the negative sample pair including a video sample and an audio sample that do not have a matching relationship; for a video sample and an audio sample in a same sample pair, extracting video feature information corresponding to the video sample through a video feature extraction model, and extracting audio feature information corresponding to the audio sample through an audio feature extraction model; determining a value of a contrastive loss function based on the video feature information and the audio feature information in the same sample pair, the contrastive loss function being configured for representing a degree of matching of the sample pair; and adjusting parameters of the video feature extraction model and the audio feature extraction model based on the value of the contrastive loss function, to obtain a trained video feature extraction model and a trained audio feature extraction model.

Another embodiment of the present disclosure includes a non-transitory computer readable storage medium containing computer-readable instructions that, when being executed, cause at least one processor to perform: constructing a set of sample pairs based on at least one video sample and at least one audio sample, the set of sample pairs including at least one positive sample pair and at least one negative sample pair, the positive sample pair including a video sample and an audio sample that have a matching relationship, and the negative sample pair including a video sample and an audio sample that do not have a matching relationship; for a video sample and an audio sample in a same sample pair, extracting video feature information corresponding to the video sample through a video feature extraction model, and extracting audio feature information corresponding to the audio sample through an audio feature extraction model; determining a value of a contrastive loss function based on the video feature information and the audio feature information in the same sample pair, the contrastive loss function being configured for representing a degree of matching of the sample pair; and adjusting parameters of the video feature extraction model and the audio feature extraction model based on the value of the contrastive loss function, to obtain a trained video feature extraction model and a trained audio feature extraction model

Details of one or more embodiments of the present disclosure are provided in the accompanying drawings and descriptions below. Other features and advantages of the present disclosure become clear with reference to the specification, the accompanying drawings, and the claims.

### BRIEF DESCRIPTION OF THE DRAWINGS

To describe the technical solutions in embodiments of the present disclosure more clearly, the following briefly introduces the accompanying drawings required for describing the embodiments. Apparently, the accompanying drawings in the following descriptions show only the embodiments of the present disclosure, and a person of ordinary skill in the art may still derive other drawings from the disclosed accompanying drawings without creative efforts that are encompassed within the scope of the present disclosure.

FIG. 1 is a schematic diagram of a solution implementation environment according to an embodiment of the present disclosure.

FIG. 2 is a schematic diagram of an audio/video matching method according to an embodiment of the present disclosure.

FIG. 3 is a flowchart of a model training method for audio/video matching according to an embodiment of the present disclosure.

FIG. 4 is a flowchart of a model training method for audio/video matching according to another embodiment of the present disclosure.

FIG. 5 is a schematic diagram of augmentation according to an embodiment of the present disclosure.

FIG. 6 is a schematic diagram of a pretraining model according to an embodiment of the present disclosure.

FIG. 7 is a flowchart of an audio/video matching method according to an embodiment of the present disclosure.

FIG. 8 is a flowchart of an audio/video matching method according to another embodiment of the present disclosure.

FIG. 9 is a schematic diagram of a historical video determining method according to an embodiment of the present disclosure.

FIG. 10 is a schematic diagram of an audio recommendation result according to an embodiment of the present disclosure.

FIG. 11 is a block diagram of a model training apparatus for audio/video matching according to an embodiment of the present disclosure.

FIG. 12 is a block diagram of a model training apparatus for audio/video matching according to another embodiment of the present disclosure.

FIG. 13 is a block diagram of an audio/video matching apparatus according to an embodiment of the present disclosure.

FIG. 14 is a block diagram of an audio/video matching apparatus according to another embodiment of the present disclosure.

FIG. 15 is a block diagram of a computer device according to an embodiment of the present disclosure.

### DESCRIPTION OF EMBODIMENTS

The technical solutions in embodiments of the present disclosure are clearly and completely described in the following with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

Before the technical solutions of the present disclosure are described, some technical background related to the present disclosure is described first. The following related technologies, as exemplary solutions, may be combined with the technical solutions of the embodiments of the present disclosure to form other embodiments, and the embodiments all fall within the protection scope of the embodiments of the present disclosure. The embodiments of the present disclosure include at least some content in the following content.

Artificial intelligence (AI) involves a theory, a method, a technology, and an application system that use a digital computer or a machine controlled by the digital computer to simulate, extend, and expand human intelligence, perceive an environment, obtain knowledge, and use knowledge to obtain an optimal result. In other words, artificial intelligence is a comprehensive technology in computer science and attempts to understand the essence of intelligence and produce a new intelligent machine that can react in a manner similar to human intelligence. Artificial intelligence is to study the design principles and implementation methods of various intelligent machines, to enable the machines to have the functions of perception, reasoning, and decision-making.

The artificial intelligence technology is a comprehensive discipline, and relates to a wide range of fields including both hardware-level technologies and software-level technologies. The basic artificial intelligence technologies generally include technologies such as a sensor, a dedicated artificial intelligence chip, cloud computing, distributed storage, a big data processing technology, an operating/interaction system, and electromechanical integration. Artificial intelligence software technologies mainly include several major directions such as a natural language processing technology, and machine learning/deep learning.

Machine learning (ML) is a multi-field interdiscipline, and relates to a plurality of disciplines such as the probability theory, statistics, the approximation theory, convex analysis, and the algorithm complexity theory. Machine learning specializes in studying how a computer simulates or implements a human learning behavior to obtain new knowledge or skills, and reorganize a related knowledge structure, to keep improving its performance. Machine learning is the core of artificial intelligence, is a basic way to make the computer intelligent, and is applied to various fields of artificial intelligence. Machine learning and deep learning generally include technologies such as an artificial neural network, a belief network, reinforcement learning, transfer learning, inductive learning, and learning from demonstrations.

Deep learning (DL) is a new research direction in the field of machine learning (ML), and is introduced into ML to make ML closer to an initial target, that is, AI. Deep learning is to learn an internal rule and an expression layer of sample data. Information obtained in these learning processes greatly helps interpretation of data such as a text, an image, and a sound. The final objective is to enable a machine to have an analysis and learning capability like a person, and to recognize data such as a text, an image, and a sound. Deep learning is a complex machine learning algorithm, and achieves effects in speech and image recognition far exceeding the effects of conventional related technologies. Deep learning has achieved many results in search technologies, data mining, machine learning, machine translation, natural language processing, multimedia learning, speech, recommendation, and personalized technologies, and other related fields. Deep learning enables a machine to imitate human activities such as seeing, hearing, and thinking, resolves many complex pattern recognition problems, and makes related technologies of artificial intelligence greatly improved.

With research and progress of artificial intelligence technologies, the artificial intelligence technologies are researched and applied to a plurality of fields, such as common smart homes, smart wearable devices, virtual assistants, smart speakers, smart marketing, unmanned driving, autonomous driving, unmanned aerial vehicles, robots, smart medical treatment, smart customer service, virtual reality (VR), augmented reality (AR), games, virtual human, and digital human. It is believed that with development of technologies, the artificial intelligence technologies are applied to more fields, and play an increasingly important value.

In one embodiment, before related data of a user is collected and in a process of collecting the related data of the user, a prompt interface and a pop-up window may be displayed, or voice prompt information may be outputted. The prompt interface, the pop-up window, or the voice prompt information is configured for prompting the user that the related data of the user is being collected. Therefore, in one embodiment, only after a confirmation operation initiated by the user for the prompt interface or the pop-up window is obtained, a related operation of obtaining the related data of the user starts to be performed. Otherwise (in other words, when the confirmation operation initiated by the user for the prompt interface or the pop-up window is not obtained), the related operation of obtaining the related data of the user ends, that is, the related data of the user is not obtained. In other words, in one embodiment, all collected user data (including video data and audio data obtained by a publisher) is collected with the consent and authorization of the user, and collection, use, and processing of related user data need to comply with related laws and regulations and standards of related countries and regions.

Before the technical solutions of the present disclosure are described, some terms used in the present disclosure are first explained and described. The following related descriptions, as exemplary solutions, may be combined with the technical solutions of the embodiments of the present disclosure to form other embodiments, and the embodiments all fall within the protection scope of the embodiments of the present disclosure. The embodiments of the present disclosure include at least some content in the following content.

Contrastive learning: It is a type of self-supervised learning. To be specific, knowledge is learned from an untagged image without relying on tagged data. Currently, contrastive learning seems to be in a state of “there is no clear definition and there is a guiding principle”, and the guiding principle is: By automatically constructing similar examples and dissimilar examples, a representation learning model needs to be learned. Through the model, the similar examples are relatively close in a projection space, and the dissimilar examples are relatively far away in the projection space.

Augmentation: Data augmentation is one of common technologies in deep learning, and is mainly for increasing a training data set to make the data set as diversified as possible, so that a trained model has a stronger generalization capability. Augmentation in the embodiments of the present disclosure relates to visual augmentation and time sequence augmentation. Visual augmentation mainly includes horizontal/vertical flipping, rotation, zooming, cutting, shearing, translation, contrast, color dithering, noise, and the like.

Background music recommendation hit ratio: It is a ratio of a quantity of posted video with background music from recommended background music to a quantity of posted videos with background music.

Ratio of posting with music: It is a ratio of the quantity of posted videos with background music to a quantity of posted videos.

Term frequency-inverse document frequency (TF-IDF): It is a common weighting technology for information retrieval and data mining. TF is a term frequency, and IDF is an inverse document frequency.

Multi-layer perception (MLP): It is also referred to as an artificial neural network (ANN). In addition to an input/output layer, a plurality of hidden layers may exist in the artificial neural network.

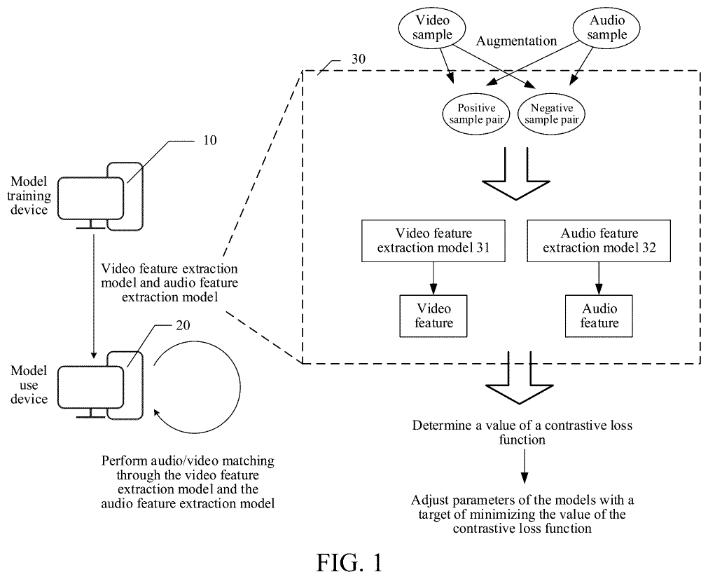

FIG. 1 is a schematic diagram of a solution implementation environment according to an embodiment of the present disclosure. The solution implementation environment may include a model training device 10 and a model use device 20.

The model training device 10 may be an electronic device such as a personal computer, a computer, a tablet computer, a server, or an intelligent robot, or some other electronic devices having a strong computing capability. The model training device 10 is configured to jointly train a video feature extraction model 31 and an audio feature extraction model 32.

In some embodiments, the video feature extraction model 31 and the audio feature extraction model 32 are jointly trained through a pretraining model 30.

In the embodiments of the present disclosure, the pretraining model 30 is a machine learning model configured to jointly train the video feature extraction model 31 and the audio feature extraction model 32. In some embodiments, the model training device 10 may train the pretraining model 30 through machine learning, so that the pretraining model 30 has good performance. For example, a video feature extraction model 31 (which may be considered as a module or a submodel in the pretraining model 30) in a trained pretraining model 30 may perform feature extraction on an input video, and an audio feature extraction model 32 (which may be considered as a module or a submodel in the pretraining model 30) in the trained pretraining model 30 may perform feature extraction on input audio.

The trained video feature extraction model 31 and audio feature extraction model 32 may be deployed in the model use device 20 for use, to extract a video feature or an audio feature, thereby implementing audio/video matching. The model use device 20 may be a terminal device such as a mobile phone, a computer, a smart television, a multimedia playback device, a wearable device, or a medical device, or may be a server.

In some embodiments, a collected video sample and a collected audio sample (including matched audio and video samples and mismatched audio and video samples, where for details of explanations and descriptions of the mismatched audio and video samples, refer to the following embodiment) are respectively augmented, to obtain an augmented video sample and an augmented audio sample.

In some embodiments, the video sample, the augmented video sample, the audio sample, and the augmented audio sample are grouped into a positive sample pair and a negative sample pair. In some embodiments, the positive sample pair includes an anchor sample and a positive sample, and the negative sample pair includes an anchor sample and a negative sample. For a specific manner for grouping the video sample, the augmented video sample, the audio sample, and the augmented audio sample into the positive sample pair and the negative sample pair, refer to the following embodiments, and details are not described herein. In some embodiments, video samples in the positive sample pair and the negative sample pair are inputted to the video feature extraction model 31, to obtain video features, and audio samples in the positive sample pair and the negative sample pair are inputted to the audio feature extraction model 32, to obtain audio features. In some embodiments, a value of a contrastive loss function is determined based on the video features and the audio features respectively corresponding to the positive sample pair and the negative sample pair, and parameters of the video feature extraction model 31 and the audio feature extraction model 32 are adjusted with a target of minimizing the value of the contrastive loss function, to obtain the trained video feature extraction model 31 and audio feature extraction model 32.

In the method provided in the embodiments of the present disclosure, operations may be performed by a computer device. The computer device is an electronic device having data computing, processing, and storage capabilities. The computer device may be a terminal such as a personal computer (PC), a tablet computer, a smartphone, a wearable device, or an intelligent robot; or may be a server. The server may be an independent physical server, a server cluster including a plurality of physical servers, a distributed system, or a cloud server providing a cloud computing service. The computer device may be the model training device 10 or the model use device 20 in FIG. 1.

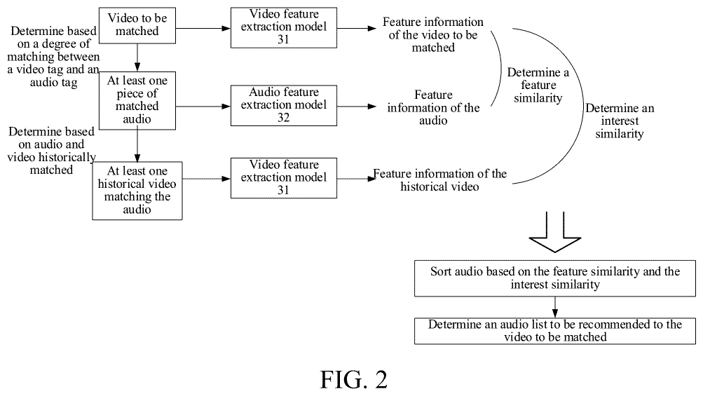

FIG. 2 is a schematic diagram of an audio/video matching method according to an embodiment of the present disclosure.

For a video that is not posted, a user may probably add background music to the video to be posted. In this case, matching audio needs to be recommended for the video to be posted. In some embodiments, the video to be posted is referred to as a video to be matched.

In a first operation, at least one audio matching the video tag is found from a music library based on a video tag (which may also be referred to as a category tag below) of the video to be matched. In some embodiments, a tag of the matching audio is the same as or has a high similarity with the tag of the video to be matched.

In a second operation, a historical video matching each piece of matching audio is determined based on a historical matching situation. In some embodiments, the historical video of the matching audio may be determined based on a historical pairing situation. For example, a video publisher records video posting of each user and a use status of background music with user permission, and determines, based on records of the video publisher, the historical video corresponding to the matching audio.

In a third operation, a video feature of the video to be matched is extracted through the trained video feature extraction model 31.

In a fourth operation, an audio feature of the matching audio is extracted through the trained audio feature extraction model 32.

For target matching audio in a plurality of pieces of matching audio, in a fifth operation, a video feature of a historical video corresponding to the target matching audio is extracted through the trained video feature extraction model 31.

In a sixth operation, a feature similarity between feature information of the video to be matched and the target matching audio is determined based on the feature information of the video to be matched and feature information of the target matching audio.

In a seventh operation, an interest similarity between the feature information of the video to be matched and the target matching audio is determined based on the feature information of the video to be matched and feature information respectively corresponding to at least one historical video corresponding to the target matching audio.

In an eighth operation, a similarity between the video to be matched and the target matching audio is determined based on a feature similarity and the interest similarity between the feature information of the video to be matched and the target matching audio.

In a ninth operation, based on similarities respectively corresponding to the video to be matched and the plurality of pieces of matching audio, the plurality of pieces of matching audio are sorted in an order of the similarities, to determine an audio list to be recommended to the video to be matched.

In the related art, video/music obtained through different targets are used for pretraining a feature extractor to extract an emb (a feature), to perform cross-modality matching. Embs obtained by a video feature extractor and an audio feature extractor that are obtained through different pretraining targets hardly match (where emb spaces are different). In the related art, a frame emb (a feature average) is further configured for representing information about a time sequence lost to a video emb (a video feature). In addition, there is a tag/target detection-based recommendation algorithm. The algorithm does not make full use of content information of a video, resulting in that richness of recommended songs is not high enough. In addition, there is a recommendation algorithm based on popular songs, but content information of video/music is not used, and background music cannot be personalized recommended.

In the technical solutions provided in the embodiments of the present disclosure, the video feature/audio feature is obtained by using the pretraining model based on contrastive learning, and by using time sequence augmentation and a corresponding training task, to promote the model to learn rhythm information in a time sequence. In addition, based on a music recommendation process of two stages of user interest, user interest is captured, to implement personalized recommendation. In addition, a song tag (emotion/scenario) is obtained based on the user interest (a comment), and the music is understood from a perspective of the user. Therefore, the technical solutions provided in the embodiments of the present disclosure can improve a hit rate of the recommended audio (which may also be understood as a possibility that the recommended audio is selected by the user to be combined and released with the video to be posted).

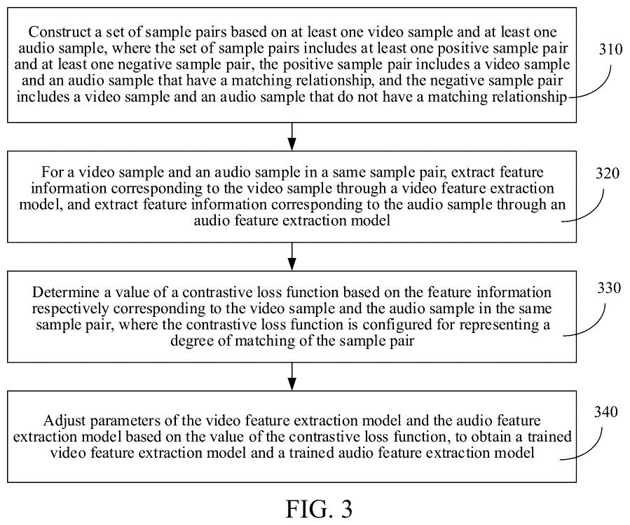

FIG. 3 is a flowchart of a model training method for audio/video matching according to an embodiment of the present disclosure. Operations of the method may be performed by the model training device introduced above. In the following method embodiments, for ease of description, only that each operation is performed by a “computer device” is used for description. The method may include at least one of the following operations (310 to 340):

Operation 310: Construct a set of sample pairs based on at least one video sample and at least one audio sample, where the set of sample pairs includes at least one positive sample pair and at least one negative sample pair, the positive sample pair includes a video sample and an audio sample that have a matching relationship, and the negative sample pair includes a video sample and an audio sample that do not have a matching relationship.

Video sample: a video sample obtained from videos historically posted by a user account. In the embodiments of the present disclosure, audio and video samples are all obtained with user permission. For example, a user A posts a video C on a platform B. The video C includes video picture content, video audio content (which may be not included) corresponding to the video picture content, and background music D of the video C. In this case, the video picture content may be considered as a video sample, and the background music D of the video C may be considered as an audio sample having a matching relationship with the video sample. In some embodiments, when posting the video C, the user A selects audio (that is, the background music D of the video C) for the video. Certainly, when posting the video C, the user may not directly select the background music D, or may listen to a large amount of other audio, but may not select the other audio as the background music of the video C. In some embodiments, audio that is listened by the user but not selected as the background music is used as an audio sample that does not have a matching relationship with the video sample.

Audio sample: audio corresponding to the video (in this case, the audio refers to background music of the video rather than music of the video content) or audio that is listened by the user when the video is posted but is not determined as the background music of the video obtained from videos historically posted.

In some embodiments, sample augmentation is performed on the at least one video sample and the at least one audio sample, to obtain an augmented video sample and an augmented audio sample (for a specific augmentation mode, refer to the following embodiment, and details are not described herein). In some embodiments, the set of sample pairs is constructed based on the at least one video sample and the at least one audio sample, or a set of sample pairs is constructed based on the at least one video sample, the at least one audio sample, at least one augmented video sample, and at least one augmented audio sample.

Positive sample pair: It is considered as two samples that have a similar or matching relationship. In some embodiments, when the positive sample pair includes two samples that have a similar relationship, the two samples in the positive sample pair may be considered as samples of the same type (for example, both are video samples). In some embodiments, when the positive sample pair includes two samples that have a matching relationship, the two samples in the positive sample pair may be considered as a video sample and an audio sample, and it is considered that the video sample and the audio sample belong to the same posted video. In some embodiments, the positive sample pair includes an anchor sample and a positive sample.

Negative sample pair: It is considered as two samples that do not have a similarity or a matching relationship. In some embodiments, when the negative sample pair includes two samples that do not have a similar relationship, the two samples in the negative sample pair may be considered as samples of the same type (for example, both are video samples). In some embodiments, When the negative sample pair includes two samples that do not have a matching relationship, the two samples in the negative sample pair may be considered as a video sample and an audio sample, and it is considered that the video sample corresponds to audio that is listened by a user of a posted video but is not used when the video is posted. In some embodiments, the negative sample pair includes an anchor sample and a negative sample.

Operation 320: For a video sample and an audio sample in a same sample pair, extract feature information (or “video feature information”) corresponding to the video sample through a video feature extraction model, and extract feature information (or “audio feature information”) corresponding to the audio sample through an audio feature extraction model.

In some embodiments, the video feature extraction model is a machine learning model on which pretraining is completed. In some embodiments, the video feature extraction model includes at least one feature extraction module. In some embodiments, in addition to the feature extraction module, the video feature extraction model further includes a linear transformation module. A specific model architecture of the video feature extraction model is not limited according to the embodiments of the present disclosure and encompassed within the scope of the present disclosure.

In some embodiments, the audio feature extraction model is a machine learning model on which pretraining is completed. In some embodiments, the audio feature extraction model includes at least one feature extraction module. In some embodiments, in addition to the feature extraction module, the audio feature extraction model further includes a linear transformation module. A specific model architecture of the audio feature extraction model is not limited according to various embodiments of the present disclosure and encompassed within the scope of the present disclosure.

In some embodiments, the video feature extraction model and the audio feature extraction model are jointly trained.

In some embodiments, for a video, frame extraction is performed through sampling, to obtain an extracted video frame sequence, and feature information corresponding to the video is further extracted through the video feature extraction model. In some embodiments, a sampling frequency is not limited. In some embodiments, an example in which the video is a one-minute video is used. The frame extraction is performed on the one-minute video at a frequency of sampling N frames per minute, to obtain N frames of images. In some embodiments, based on pixels of each frame of image, a pixel matrix corresponding to the frame of image is determined. In some embodiments, the N frames of images correspond to a matrix with a matrix dimension of 3*a*b*N, where 3 represents a value of RGB three channels, a and b respectively represent a quantity of pixels in a horizontal direction and a vertical direction of an image, N represents a quantity of images obtained through frame extraction, and N, a, and b are positive integers. In some embodiments, the matrix (or considered as the extracted video frame sequence) with the dimension of 3*a*b*N is used as an input of the video feature extraction model, to obtain corresponding feature information.

In some embodiments, for a segment of audio, frame extraction is performed through sampling, to obtain an extracted audio frame sequence, and feature information corresponding to the segment of video is further extracted through the video feature extraction model. In some embodiments, a sampling frequency is not limited. In some embodiments, an example in which the audio is a one-minute audio is used. The frame extraction is performed on the one-minute video file (in some embodiments, the audio file is in a wav format) at a frequency of sampling N frames per minute, to obtain N frame extraction results. In some embodiments, based on beat (beat information of audio) of each frame extraction result, an element size corresponding to a frame is determined. In some embodiments, the N frame extraction results correspond to a matrix with a matrix dimension of 1*N. In some embodiments, the matrix with the dimension of 1*N is used as an input of the audio feature extraction model, to obtain corresponding feature information.

In some embodiments, the feature information is a feature vector. In the embodiments of the present disclosure, a dimension of a feature vector outputted by the video feature extraction model or the audio feature extraction model is not limited. A specific model architecture of the video feature extraction model is not limited. The video feature extraction model includes, but is not limited to, a convolutional module, a pooling module, and the like. A specific model architecture of the audio feature extraction model is not limited. The audio feature extraction model includes, but is not limited to, a convolutional module, a pooling module, and the like.

Operation 330: Determine a value of a contrastive loss function based on the feature information respectively corresponding to the video sample and the audio sample in the same sample pair, where the contrastive loss function is configured for representing a degree of matching of the sample pair.

Contrastive loss function: a function configured for representing a degree of matching of the sample pair. In some embodiments, the value of the contrastive loss function can reflect a degree of matching of the positive sample pair and a degree of matching of the negative sample pair. In some embodiments, gradient descent update is performed on the value of the contrastive loss function, to improve the degree of matching of the positive sample pair and reduce the degree of matching of the negative sample pair.

Operation 340: Adjust parameters of the video feature extraction model and the audio feature extraction model based on the value of the contrastive loss function, to obtain a trained video feature extraction model and a trained audio feature extraction model.

In some embodiments, the parameters of the video feature extraction model and the audio feature extraction model are adjusted with a target of minimizing the value of the contrastive loss function, to obtain the trained video feature extraction model and trained the audio feature extraction model.

Certainly, a method of adjusting the model parameter based on the value of the contrastive loss function is not limited according to various embodiments of the present disclosure.

In the technical solutions provided in the embodiments of the present disclosure, the video feature extraction model and the audio feature extraction model are jointly trained through contrastive learning. During joint training, because both the video feature extraction model and the audio feature extraction model can learn features of a video modality and an audio modality, and are trained through contrastive learning, a feature extraction capability of the video feature extraction model for a video and a feature extraction capability of the audio feature extraction model for audio can be improved. Therefore, the audio recommended to the video to be matched is determined based on a matching degree between the video feature extracted through the video feature extraction model and the audio feature extracted through the audio feature extraction model, to improve a background music hit ratio.

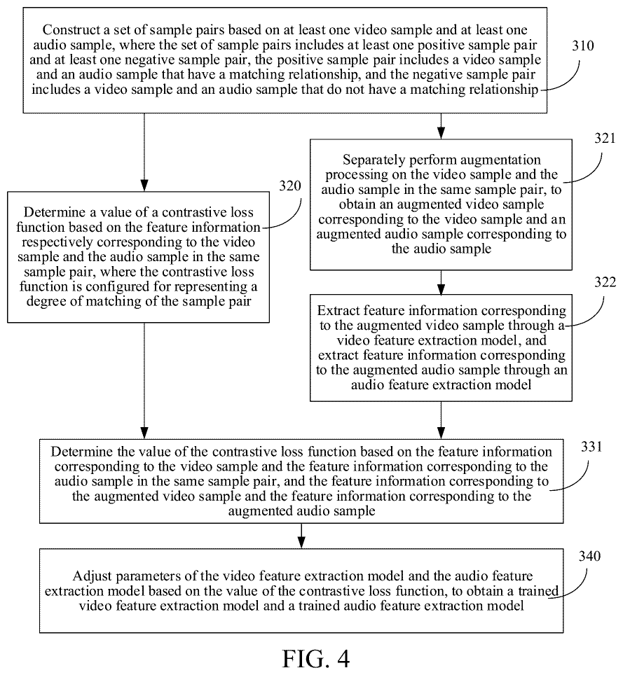

FIG. 4 is a flowchart of a model training method for audio/video matching according to another embodiment of the present disclosure. Operations of the method may be performed by the model training device introduced above. In the following method embodiments, for ease of description, only that each operation is performed by one or more processors of a “computer device” is used for description, although multiple computer devices may be used in some embodiments. The method may include at least one of the following operations (310 to 340):

Operation 310: Construct a set of sample pairs based on at least one video sample and at least one audio sample, where the set of sample pairs includes at least one positive sample pair and at least one negative sample pair, the positive sample pair includes a video sample and an audio sample that have a matching relationship, and the negative sample pair includes a video sample and an audio sample that do not have a matching relationship.

Operation 320: For a video sample and an audio sample in a same sample pair, extract feature information corresponding to the video sample through a video feature extraction model, and extract feature information corresponding to the audio sample through an audio feature extraction model.

Operation 321: Separately perform augmentation processing on a video sample and an audio sample in a same sample pair, to obtain an augmented video sample corresponding to the video sample and an augmented audio sample corresponding to the audio sample.

In the embodiments of the present disclosure, an augmentation mode for the audio sample and the video sample includes time sequence augmentation. The time sequence augmentation includes order augmentation, speed augmentation, and direction augmentation. For specific implementations of the three types of augmentation, refer to the following operations. The three types of augmentation may exist alone, or may be combined with each other. Certainly, the three types of augmentation may alternatively be performed on the same sample at the same time. A specific combination form of augmentation is not limited according to various embodiments of the present disclosure.

In the embodiments of the present disclosure, an augmentation mode for the video sample further includes visual augmentation. Certainly, a specific type of the visual augmentation is not limited and encompassed within the scope of the present disclosure. In some embodiments, the visual augmentation includes color conversion, random size change, image matting, horizontal flipping, and the like.

In the embodiments of the present disclosure, augmentation for the video sample includes at least one of the time sequence augmentation or the visual augmentation. Augmentation for the audio sample includes any one or more types in the time sequence augmentation. A specific augmentation mode for the audio sample and the video sample is not limited according to various embodiment of the present disclosure and encompassed within the scope of the present disclosure.

In some embodiments, when the augmentation mode is order augmentation, operation 321 includes at least one of operation 321-1 to operation 321-3 (not shown in the figure).

Operation 321-1: For the sample pair in the set, segment the video sample in the sample pair, to obtain a plurality of video segments, where the feature information corresponding the video sample is feature information corresponding to a first video segment obtained by extracting the first video segment in the plurality of video segments through the video feature extraction model; and the feature information corresponding to the audio sample is feature information corresponding to a first audio segment obtained by extracting the first audio segment through the audio feature extraction model, where the first audio segment is an audio segment corresponding to the first video segment.

In some embodiments, a method of segmenting the video sample is not limited. In some embodiments, the segmentation is uniform segmentation or non-uniform segmentation. Certainly, the present disclosure does not limit a granularity of the segmentation. In some embodiments, a video sample is evenly divided into M segments, where M is a positive integer. In some embodiments, the first video segment is any one of the M segments of videos. In some embodiments, sampling frame extraction is performed on the first video segment, to obtain an extracted video frame sequence that can be inputted to the video feature extraction model. In some embodiments, the first video segment is the m^{th} segment in the M segments, where M is a positive integer not greater than M. In some embodiments, the first audio segment is the m^{th} segment in the audio sample divided into M segments and matching the video sample.

Operation 321-2: Select, from the plurality of video segments, a second video segment different from the first video segment as the augmented video sample, where the feature information (or “augmented video feature information”) corresponding to the augmented video sample is feature information corresponding to the second video segment obtained by extracting the second video segment through the video feature extraction model.

In some embodiments, the second video segment is any one of the M segments of videos and is different from the first video segment. In some embodiments, sampling frame extraction is performed on the second video segment, to obtain an extracted video frame sequence that can be inputted to the video feature extraction model. In some embodiments, the second video segment is the j^{th} segment in the M segments, where j is a positive integer that is different from M and is not greater than M.

Operation 321-3: Determine a second audio segment as the augmented audio sample, where the second audio segment is an audio segment corresponding to the second video segment, and the feature information (or “augmented audio feature information”) corresponding to the augmented audio sample is feature information corresponding to the second audio segment obtained by extracting the second audio segment through the audio feature extraction model.

In some embodiments, the second audio segment is the j^{th} segment in the audio sample divided into M segments and matching the video sample.

In some embodiments, when the augmentation mode is speed augmentation, operation 321 includes at least one of operation 321-4 to operation 321-7 (not shown in the figure).

Operation 321-4: Select at least one frame from the video sample at a first sampling frequency, to obtain a first extracted video frame sequence, where the feature information corresponding to the video sample is feature information corresponding to the first extracted video frame sequence obtained by extracting the first extracted video frame sequence through the video feature extraction model.

In some embodiments, the video sample in operation 321-4 may be a video segment after the order augmentation is performed. In some embodiments, an original video sample is a four-minute matrix, and is divided into four one-minute video segments after the order augmentation is performed. In this case, operation 321-4 may be sampling any one of the video segments. Certainly, the video sample in operation 321-4 may alternatively be considered as an original complete video on which the order augmentation is not performed.

The first sampling frequency and a second sampling frequency may be considered as frequencies of the frame extraction for the video. In some embodiments, if the sampling frequency (a frame extraction frequency) is 12 frames per minute, for a one-minute video, 12 frames need to be selected from the video, to obtain the extracted video frame sequence (extracted video frame images). In some embodiments, based on pixels in each frame of image, an input to be inputted to the video feature extraction model is determined. In some embodiments, the input is a matrix of 3*a*b*N.

Operation 321-5: Select at least one frame from the video sample at the second sampling frequency, to obtain a second extracted video frame sequence as the augmented video sample, where the feature information corresponding to the augmented video sample is feature information corresponding to the second extracted video frame sequence obtained by extracting the second extracted video frame sequence through the video feature extraction model; and the second sampling frequency is different from the first sampling frequency.

In some embodiments, the second sampling frequency is the same as or different from the first sampling frequency. In some embodiments, the first sampling frequency is k1 frames per minute, and the second sampling frequency is k2 frames per minute, where k2 is a positive integer less than k1. In some embodiments, for a one-minute video, a pixel matrix corresponding to the first extracted video frame sequence obtained at the first sampling frequency is 3*a*b*k1. In some embodiments, for a one-minute video, there are only k2 frames in the second extracted video frame sequence obtained at the second sampling frequency, and a corresponding pixel matrix is 3*a*b*k2. In this case, matrix dimensions of 3*a*b*k1 and 3*a*b*k2 are inconsistent. In this case, the second extracted video frame sequence is supplemented. For example, blank images (values of RGB three channels are all 0) are used for filling k1-k2 frames, so that a pixel matrix corresponding to the supplemented second extracted video frame sequence is also 3*a*b*k1.

In some embodiments, when a dimension of a pixel value matrix corresponding to a second video sequence is inconsistent with a dimension of a pixel value matrix corresponding to a first video sequence, 0 is used for filling, so that the dimension of a pixel value matrix corresponding to a filled second video sequence is consistent with the dimension of the pixel value matrix corresponding to the first video sequence.

Operation 321-6: Select at least one frame from the audio sample at a third sampling frequency, to obtain a first extracted audio frame sequence, where the feature information corresponding to the audio sample is feature information corresponding to the first extracted audio frame sequence obtained by extracting the first extracted audio frame sequence through the audio feature extraction model.

The third sampling frequency and a fourth sampling frequency may be considered as frequencies of the frame extraction for the audio. In some embodiments, if the sampling frequency (the frame extraction frequency) is 12 frames per minute, for a one-minute audio, 12 frames need to be selected from the audio, to obtain the extracted audio frame sequence. In some embodiments, each frame of audio corresponds to a beat value, and a 1*12 matrix is obtained based on beat values respectively corresponding to 12 frames, to determine an input to be inputted to the video feature extraction model. In some embodiments, the input is a matrix of 1*12.

Operation 321-7: Select at least one frame from the audio sample at the fourth sampling frequency, to obtain a second extracted audio frame sequence as the augmented audio sample, where the feature information corresponding to the augmented audio sample is feature information corresponding to the second extracted audio frame sequence obtained by extracting the second extracted audio frame sequence through the audio feature extraction model; and the fourth sampling frequency is different from the third sampling frequency.

In some embodiments, the fourth sampling frequency is the same as or different from the third sampling frequency. In some embodiments, the third sampling frequency is k3 frames per minute, and the fourth sampling frequency is k4 frames per minute, where k4 is a positive integer less than k3. In some embodiments, for a one-minute audio, a matrix corresponding to the first extracted audio frame sequence obtained at the third sampling frequency is 1*k3. In some embodiments, for a one-minute video, there are only k4 frames in the second extracted audio frame sequence obtained at the fourth sampling frequency, and a corresponding matrix is 1*k4. In this case, matrix dimensions of 1*k4 and 1*k3 are inconsistent. In this case, the second extracted audio frame sequence is supplemented. For example, blanks (where the beat value is 0) are used for filling k3-k4 frames, so that a matrix corresponding to a filled second extracted audio frame sequence is also 1*k3.

In some embodiments, when the augmentation mode is direction augmentation, operation 321 includes at least one of operation 321-8 to operation 321-11 (not shown in the figure).

Operation 321-8: Select at least one frame through sequential sampling of the video sample, to obtain a third extracted video frame sequence, where the feature information corresponding to the video sample in the sample pair is feature information corresponding to the third extracted video frame sequence obtained by extracting the third extracted video frame sequence through the video feature extraction model.

In some embodiments, the video sample in operation 321-8 may be a video segment after the order augmentation is performed. In some embodiments, an original video sample is a four-minute video, and is divided into four one-minute video segments after the order augmentation is performed. In this case, operation 321-8 may be sampling any one of the video segments. Certainly, the video sample in operation 321-4 may alternatively be considered as an original complete video on which the order augmentation is not performed.

In some embodiments, when the sampling frequencies are consistent and sampling directions are consistent, the third extracted video frame sequence and the first extracted video frame sequence may be the same sequence.

Certainly, when the sampling frequencies are inconsistent or the sampling directions are inconsistent, the third extracted video frame sequence and the first extracted video frame sequence are different sequences.

Operation 321-9: Select at least one frame through reverse sampling of the video sample, to obtain a fourth extracted video frame sequence as the augmented video sample, where the feature information corresponding to the augmented video sample is feature information corresponding to the fourth extracted video frame sequence obtained by extracting the fourth extracted video frame sequence through the video feature extraction model.

In some embodiments, similarly, for a one-minute video segment, assuming that sampling frequencies of sequential sampling and reverse sampling are the same, the third extracted video frame sequence and the fourth extracted video frame sequence essentially have the same pictures, but sorting modes are different. Assuming that 12 frames of pictures are selected and are numbered 1 to 12, the third extracted video frame sequence corresponds to the pictures 1 to 12, and the fourth extracted video frame sequence corresponds to the pictures 12 to 1.

Operation 321-10: Select at least one frame through sequential sampling of the audio sample, to obtain a third extracted audio frame sequence, where the feature information corresponding to the audio sample is feature information corresponding to the third extracted audio frame sequence obtained by extracting the third extracted audio frame sequence through the audio feature extraction model.

In some embodiments, the audio sample in operation 321-10 may be an audio segment after the order augmentation is performed. In some embodiments, an original audio sample is a four-minute audio, and is divided into four one-minute video segments after the order augmentation is performed. In this case, operation 321-10 may be sampling any one of the audio segments. Certainly, the audio sample in operation 321-10 may alternatively be considered as an original complete audio on which the order augmentation is not performed.

In some embodiments, when the sampling frequencies are consistent and sampling directions are consistent, the third extracted audio frame sequence and the first extracted audio frame sequence may be the same sequence.

Certainly, when the sampling frequencies are inconsistent or the sampling directions are inconsistent, the third extracted audio frame sequence and the first extracted audio frame sequence are different sequences.

Operation 321-11: Select at least one frame through reverse sampling of the audio sample, to obtain a fourth extracted audio frame sequence as the augmented audio sample, where the feature information corresponding to the augmented audio sample is feature information corresponding to the fourth extracted audio frame sequence obtained by extracting the fourth extracted audio frame sequence through the audio feature extraction model.

In some embodiments, similarly, for a one-minute audio segment, assuming that sampling frequencies of sequential sampling and reverse sampling are the same, the third extracted audio frame sequence and the fourth extracted audio frame sequence essentially have the same beat value, but sorting modes are different. Assuming that 12 beat values are selected and are numbered 1 to 12, the third extracted audio frame sequence corresponds to the beat values 1 to 12, and the fourth extracted audio frame sequence corresponds to the beat values 12 to 1.

Operation 322: Extract feature information corresponding to the augmented video sample through the video feature extraction model, and extract feature information corresponding to the augmented audio sample through the audio feature extraction model.

After the augmented video sample and the augmented audio sample are generated through random combination, the positive sample pair and the negative sample need to be reconstructed. Operation 322 and operation 320 are performed.

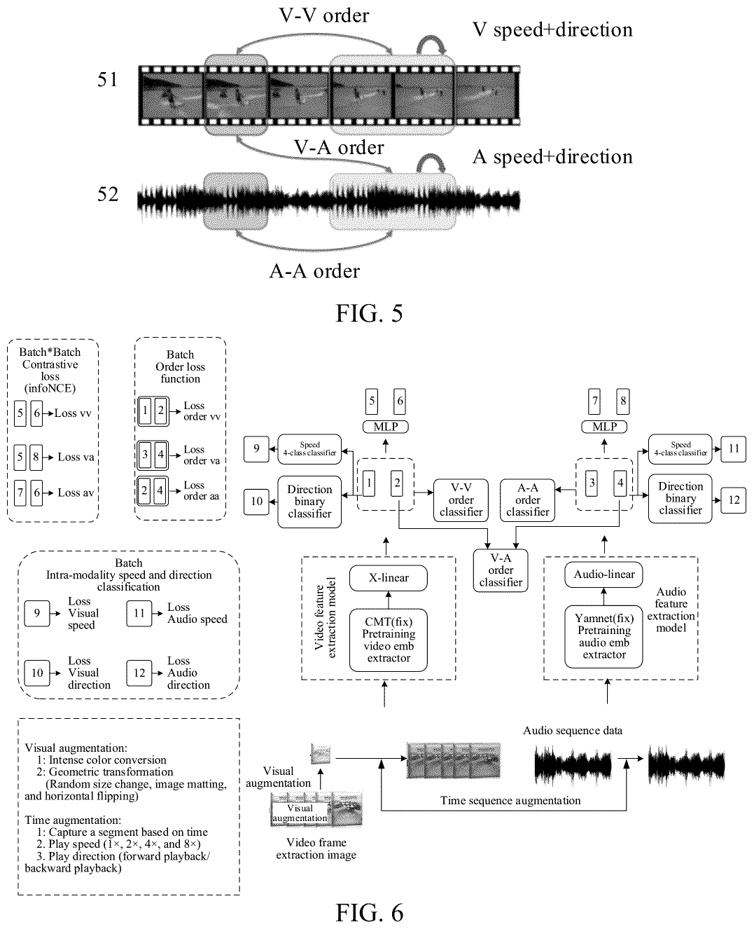

In some embodiments, FIG. 5 is a schematic diagram of augmentation. 51 indicates a video sample, and 52 indicates a correspondingly matched audio sample.

Operation 331: Determine the value of the contrastive loss function based on the video feature information corresponding to the video sample and the audio feature information corresponding to the audio sample in the same sample pair, and the feature information corresponding to the augmented video sample and the feature information corresponding to the augmented audio sample.

In some embodiments, the feature information corresponding to the video sample and the feature information corresponding to the audio sample, and the feature information corresponding to the augmented video sample and the feature information corresponding to the augmented audio sample that are configured for calculating the value of the contrastive loss function are feature information that is obtained through the video feature extraction model and the audio feature extraction model and then using an MLP layer.

In the embodiments of the present disclosure, at least three modes of constructing the positive and negative sample pairs are included for the video sample, the audio sample, the augmented video sample, and the augmented audio sample. The anchor sample and the positive sample form the positive sample pair, and the anchor sample and the negative sample form the negative sample pair.

In some embodiments, the augmented video sample is used as a first anchor sample, an original video sample corresponding to the augmented video sample is used as a first positive sample, and another video sample is used as a first negative sample. In some embodiments, an augmented video sample corresponding to the i^{th} video segment of a video A is used as the first anchor sample, the i^{th} video segment of the video A is used as the first positive sample, and the i^{th} video segment of a video B is used as the first negative sample, where i is a positive integer. In some embodiments, the first anchor sample and the first positive sample form a first positive sample pair, and the first anchor sample and the first negative sample form a first negative sample pair.

In some embodiments, the augmented video sample is used as a second anchor sample, an audio sample matching an original video sample corresponding to the augmented video sample is used as a second positive sample, and another audio sample is used as a second negative sample. In some embodiments, an augmented video sample corresponding to the i^{th} segment of the video A is used as the second anchor sample, the i^{th} segment of audio C matching the video A is used as the second positive sample, where i is a positive integer, and the i^{th} segment of another audio that does not match the video A is used as the second negative sample. In some embodiments, the second anchor sample and the second positive sample form a second positive sample pair, and the second anchor sample and the second negative sample form a second negative sample pair.

In some embodiments, the augmented audio sample is used as a third anchor sample, a video sample matching an original audio sample corresponding to the augmented audio sample is used as a third positive sample, and another video sample is used as a third negative sample. In some embodiments, an augmented audio sample corresponding to the i^{th} segment of audio A is used as the third anchor sample, the i^{th} segment of a video C matching the audio A is used as the third positive sample, where i is a positive integer, and the i^{th} segment of another video that does not match the audio A is used as the third negative sample. In some embodiments, the third anchor sample and the third positive sample form a third positive sample pair, and the third anchor sample and the third negative sample form a third negative sample pair.

A construction mode of positive and negative sample pairs is not limited according to various embodiment of the present disclosure and encompassed within the scope of the present disclosure.

In some embodiments, operation 331 includes at least one of operation 331-1 to operation 331-4 (not shown in the figure).

Operation 331-1: Determine a first contrastive loss based on the feature information corresponding to the video sample and the feature information corresponding to the augmented video sample.

In some embodiments, the first contrastive loss is determined by using the feature information respectively corresponding to the first positive sample pair and the first negative sample.

Operation 331-2: Determine a second contrastive loss based on the feature information corresponding to the video sample and the feature information corresponding to the augmented audio sample.

In some embodiments, the second contrastive loss is determined by using the feature information respectively corresponding to the second positive sample pair and the second negative sample.

Operation 331-3: Determine a third contrastive loss based on the feature information corresponding to the augmented video sample and the feature information corresponding to the audio sample.

In some embodiments, the second contrastive loss is determined by using the feature information respectively corresponding to the third positive sample pair and the third negative sample.

Operation 331-4: Determine the value of the contrastive loss function based on the first contrastive loss, the second contrastive loss, and the third contrastive loss.

In some embodiments, weighted summation is performed on the first contrastive loss, the second contrastive loss, and the third contrastive loss, to determine the value of the contrastive loss function.

In some embodiments, the first contrastive loss, the second contrastive loss, and the third contrastive loss are directly summed, to determine the value of the contrastive loss function.

In some embodiments, L_{CRL}=Eᵥ_{ᵢ}_{,a}_{ᵢ}[ [symbol] ᵥᵥ(vᵢ^{r}, [symbol] ᵢ^{vv}, [symbol] ᵢ^{vv})+ [symbol] ᵥₐ(vᵢ^{r}, [symbol] ᵢ^{va}, [symbol] ᵢ^{va})+ [symbol] ₐᵥ (aᵢ^{r}, [symbol] ᵢ^{av}, [symbol] ᵢ^{av})], where L_{CRL} represents the value of the contrastive loss function. In some embodiments, [symbol] ᵥᵥ(vᵢ^{r}, [symbol] ᵢ^{vv}, [symbol] ᵢ^{vv}) is the first contrastive loss, [symbol] ᵥₐ(vᵢ^{r}, [symbol] ᵢ^{va}, [symbol] ᵢ^{va}) is the second contrastive loss, [symbol] ᵥₐ(vᵢ^{r}, [symbol] ᵢ^{av}, [symbol] ᵢ^{av}) is the third contrastive loss, and E represents solving an expectation. v represents the video sample, and a represents the audio sample. i represents a position of a segment in a complete video, r represents an augmentation function value, and augmentation implemented in different modes corresponds to different r. [symbol] represents the positive sample, and [symbol] represents the negative sample.

In some embodiments,

$${ℓ}_{va} ( {v}_{i}^{r} , {𝒫}_{i}^{va} , {𝒩}_{i}^{va} ) = {\sum }_{p , w ∈ {𝒫}_{i}^{va}} w log ( \frac{d ( {ϕ}_{v} ( {v}_{i}^{r} ) , p}{d ( {ϕ}_{v} ( {v}_{i}^{r} ) , p ) + {\sum }_{n ∈ {𝒩}_{i}^{va}} d ( {ϕ}_{v} ( {v}_{i}^{r} ) , n )} ) \cdot and d ( x , y ) = exp ( \frac{1}{λ} \frac{{x}^{⊤} y}{{‖ x ‖}_{2} {‖ y ‖}_{2}} ) \cdot 𝒫$$

is the positive sample, [symbol] is the negative sample, and w represents a weight, and is a learnable parameter in a model.

In some embodiments, when the augmentation mode is order augmentation, the method further includes at least one of operation 332 to operation 335 (not shown in the figure).

Operation 332: Determine an order of the first video segment and the second video segment through a first order classifier based on the feature information corresponding to the first video segment and the feature information corresponding to the second video segment.

The first order classifier is a binary classifier. In some embodiments, classification results are 0 and 1, where 1 indicates a sequential order, and 0 indicates a reverse order. In some embodiments, the first video segment is the first segment in the complete video, and the second video segment is the second segment in the complete video. Therefore, it is determined, through the first order classifier based on the feature information corresponding to the first video segment and the feature information corresponding to the second video segment, that the order of the first video segment and the second video segment is that the first video segment is before the second video segment, that is, the sequential order. In this case, an output of the first order classifier is 1.

Operation 333: Determine an order of the first audio segment and the second audio segment through a second order classifier based on the feature information corresponding to the first audio segment and the feature information corresponding to the second audio segment.

The second order classifier is a binary classifier. In some embodiments, classification results are 0 and 1, where 1 indicates a sequential order, and 0 indicates a reverse order. In some embodiments, the first audio segment is the first segment in the complete audio, and the second audio segment is the second segment in the complete audio. Therefore, it is determined, through the second order classifier based on the feature information corresponding to the first audio segment and the feature information corresponding to the second audio segment, that the order of the first audio segment and the second audio segment is that the first audio segment is before the second audio segment, that is, the sequential order. In this case, an output of the second order classifier is 1.

Operation 334: Determine an order of the second video segment and the second audio segment through a third order classifier based on the feature information corresponding to the second video segment and the feature information corresponding to the second audio segment.

The third order classifier is a binary classifier. In some embodiments, classification results are 0 and 1, where 1 indicates a sequential order, and 0 indicates a reverse order. In some embodiments, the second video segment is the first segment in the complete video, and the second audio segment is the second segment in the complete audio. The complete video matches the complete audio. Therefore, it is determined, through the third order classifier based on the feature information corresponding to the second video segment and the feature information corresponding to the second audio segment, that the order of the second video segment and the second audio segment is that the second video segment is before the second audio segment, that is, the sequential order. In this case, an output of the third order classifier is 1.

In some embodiments, the first order classifier, the second order classifier, and the third order classifier are different classifiers.

Operation 335: Determine an order classification loss based on the orders determined by the first order classifier, the second order classifier, and the third order classifier, where the order classification loss is configured for reflecting prediction accuracy of the orders, and the order classification loss is configured for adjusting a model parameter with reference to the value of the contrastive loss function.

In some embodiments, weighted summation is performed on losses corresponding to the sequential orders determined by the first order classifier, the second order classifier, and the third order classifier, to determine the order classification loss.

In some embodiments, losses corresponding to the sequential orders determined by the first order classifier, the second order classifier, and the third order classifier are summed, to determine the order classification loss.

In some embodiments, the order classification loss is determined through unsupervised learning.

In some embodiments, when the augmentation mode is speed augmentation, the method further includes at least one of operation 336 to operation 338 (not shown in the figure).

Operation 336: Determine a predicted sampling frequency of the first extracted video frame sequence through a first speed classifier based on the feature information corresponding to the first extracted video frame sequence, and determine a predicted sampling frequency of the second extracted video frame sequence through the first speed classifier based on the feature information corresponding to the second extracted video frame sequence.

The first speed classifier is a 4-class classifier. In some embodiments, classification results are 1, 2, 4, and 8, where 1 indicates 1-time sampling, 2 indicates 2-time sampling, 3 indicates 3-time sampling, and 4 indicates 4-time sampling. In some embodiments, the first extracted video frame sequence is obtained through 1-time sampling. In this case, the predicted sampling frequency of the first extracted video frame sequence is determined as 1 through the first speed classifier based on the feature information corresponding to the first extracted video frame sequence. Correspondingly, a mode of determining the sampling frequency of the second extracted video frame sequence is the same as the mode of determining the sampling frequency of the first extracted video frame sequence.

Operation 337: Determine a predicted sampling frequency of the first extracted audio frame sequence through a second speed classifier based on the feature information corresponding to the first extracted audio frame sequence, and determine a predicted sampling frequency of the second extracted audio frame sequence through the second speed classifier based on the feature information corresponding to the second extracted audio frame sequence.

The second speed classifier is a 4-class classifier. In some embodiments, classification results are 1, 2, 4, and 8, where 1 indicates 1-time sampling, 2 indicates 2-time sampling, 3 indicates 3-time sampling, and 4 indicates 4-time sampling. In some embodiments, the first extracted audio frame sequence is obtained through 1-time sampling. In this case, the predicted sampling frequency of the first extracted audio frame sequence is determined as 1 through the first speed classifier based on the feature information corresponding to the first extracted audio frame sequence. A mode of determining the sampling frequency of the second extracted audio frame sequence is the same as the mode of determining the sampling frequency of the first extracted audio frame sequence.

In some embodiments, the first speed classifier and the second speed classifier are the same classifier.

Operation 338: Determine a speed classification loss based on the predicted sampling frequencies determined by the first speed classifier and the second speed classifier, where the speed classification loss is configured for reflecting prediction accuracy of the sampling frequencies, and the speed classification loss is configured for adjusting a model parameter with reference to the value of the contrastive loss function.

In some embodiments, the speed classification loss is determined through unsupervised learning.

In some embodiments, when the augmentation mode is direction augmentation, the method further includes at least one of operation 339 to operation 339-2 (not shown in the figure).

Operation 339: Determine a sampling direction of the third extracted video frame sequence through a first direction classifier based on the feature information corresponding to the third extracted video frame sequence, and determine a sampling direction of the fourth extracted video frame sequence through the first direction classifier based on the feature information corresponding to the fourth extracted video frame sequence.

The first direction classifier is a binary classifier. In some embodiments, classification results are 0 and 1, where 1 indicates a sequential direction, and 0 indicates a reverse direction. In some embodiments, the third extracted video frame sequence is obtained through sequential sampling. In this case, it is determined, through the first direction classifier based on the feature information corresponding to the third extracted video frame sequence, that the sampling direction of the third extracted video frame sequence is sequential. In this case, an output of the first direction classifier is 1. A mode of determining the sampling direction of the fourth extracted video frame sequence is the same as the mode of determining the sampling direction of the third extracted video frame sequence.

Operation 339-1: Determine a sampling direction of the third extracted audio frame sequence through a second direction classifier based on the feature information corresponding to the third extracted audio frame sequence, and determine a sampling direction of the fourth extracted audio frame sequence through the second direction classifier based on the feature information corresponding to the fourth extracted audio frame sequence.

The second direction classifier is a binary classifier. In some embodiments, classification results are 0 and 1, where 1 indicates a sequential direction, and 0 indicates a reverse direction. In some embodiments, the third extracted audio frame sequence is obtained through sequential sampling. In this case, it is determined, through the second direction classifier based on the feature information corresponding to the third extracted audio frame sequence, that the sampling direction of the third extracted audio frame sequence is sequential. In this case, an output of the second direction classifier is 1. A mode of determining the sampling direction of the fourth extracted audio frame sequence is the same as the mode of determining the sampling direction of the third extracted audio frame sequence.

In some embodiments, the first direction classifier and the second direction classifier may be the same classifier, or classifiers of the same type.

Operation 339-2: Determine a direction classification loss based on the sampling directions determined by the first direction classifier and the second direction classifier, where the direction classification loss is configured for reflecting prediction accuracy of the sampling directions, and the direction classification loss is configured for adjusting a model parameter with reference to the value of the contrastive loss function.

In some embodiments, the direction classification loss is determined through unsupervised learning.

Operation 340: Adjust parameters of the video feature extraction model and the audio feature extraction model based on the value of the contrastive loss function, to obtain a trained video feature extraction model and a trained audio feature extraction model.

In some embodiments, the parameters of the video feature extraction model and the audio feature extraction model are adjusted based on the value of the contrastive loss function, and the order classification loss, the direction classification loss, and the speed classification loss, to obtain the trained video feature extraction model and the trained audio feature extraction model.

In some embodiments, LTEMP=Lspeed+Ldirection+Lorder, where Lorder is the order classification loss, Lspeed is the speed classification loss, Ldirection is the direction classification loss, and LTEMP is a total loss of time sequence augmentation.

In some embodiments, L SSL=LCRL+ΔLTEMP, where LSSL represents a total loss, LCRL represents the value of the contrastive loss function. A is a preset parameter 0.5.

FIG. 6 is a schematic diagram of a pretraining model. In some embodiments, the pretraining model includes the video feature extraction model, the audio feature extraction model, the speed classifier, the direction classifier, a V-V order classifier (the first order classifier), an A-A order classifier (the second order classifier), and a V-A order classifier (the third order classifier). In some embodiments, the video feature extraction model includes CNN meet transformer (CMT, a pretraining video feature extractor) and X-linear (a linear module). In some embodiments, the audio feature extraction model includes YAMNet (a pretraining audio feature extractor) and audio-linear (a linear module). In some embodiments, a block numbered 1 in the figure represents the feature information obtained from the video sample through the video feature extraction model; a block numbered 2 in the figure represents the feature information obtained from the augmented video sample through the video feature extraction model; a block numbered 3 in the figure represents the feature information obtained from the audio sample through the audio feature extraction model; and a block numbered 4 in the figure represents the feature information obtained from the augmented audio sample through the audio feature extraction model. In some embodiments, a block numbered 5 in the figure represents an output feature obtained from the feature information that is obtained from the video sample through the video feature extraction model and then through the MLP, a block numbered 6 in the figure represents an output feature obtained from the feature information that is obtained from the augmented video sample through the video feature extraction model and then through the MLP, a block numbered 7 in the figure represents an output feature obtained from the feature information that is obtained from the audio sample through the audio feature extraction model and then through the MLP, and a block numbered 8 in the figure represents an output feature obtained from the feature information that is obtained from the augmented audio sample through the audio feature extraction model and then through the MLP. In some embodiments, a block numbered 9 in the figure represents a result obtained from the feature information that is obtained from the video sample or the augmented video sample through the video feature extraction model and then through the speed classifier, a block numbered 10 in the figure represents a result obtained from the feature information that is obtained from the video sample or the augmented video sample through the video feature extraction model and then through the direction classifier, a block numbered 11 in the figure represents a result obtained from the feature information that is obtained from the audio sample or the augmented audio sample through the audio feature extraction model and then through the speed classifier, and a block numbered 12 in the figure represents a result obtained from the feature information that is obtained from the audio sample or the augmented audio sample through the audio feature extraction model and then through the direction classifier. In some embodiments, the first contrastive loss is calculated based on the block numbered 5 and the block numbered 6, the second contrastive loss is calculated based on the block numbered 5 and the block numbered 8, and the third contrastive loss is calculated based on the block numbered 7 and the block numbered 6. In some embodiments, the first order loss is calculated based on the block numbered 1 and the block numbered 2, the second order loss is calculated based on the block numbered 3 and the block numbered 4, and the third order loss is calculated based on the block numbered 2 and the block numbered 4. In some embodiments, the speed classification loss is calculated based on the block numbered 9 or the block numbered 11. In some embodiments, the speed classification loss is calculated based on the block numbered 10 or the block numbered 12.

In the technical solutions provided in the embodiments of the present disclosure, sample augmentation and contrastive learning are combined, so that both the video feature extraction model and the audio feature extraction model can learn more features, which facilitates a downstream audio/video matching task.

In addition, during augmentation, in addition to visual augmentation, time sequence augmentation is further introduced, so that both the video feature extraction model and the audio feature extraction model can learn more features of time sequences, which facilitates enriching feature extraction of the video feature extraction model and the audio feature extraction model.

Specifically, during calculation of the contrastive loss, three different contrastive losses are constructed. Features of positive sample pairs and negative sample pairs are learned from different dimensions, so that a feature distance of the video feature extraction model and the audio feature extraction model between the positive sample pairs is closer, and a feature distance between the negative sample pairs is farther. Therefore, feature extraction capabilities of the video feature extraction model and the audio feature extraction model are improved, thereby facilitating improving performance of model representation.

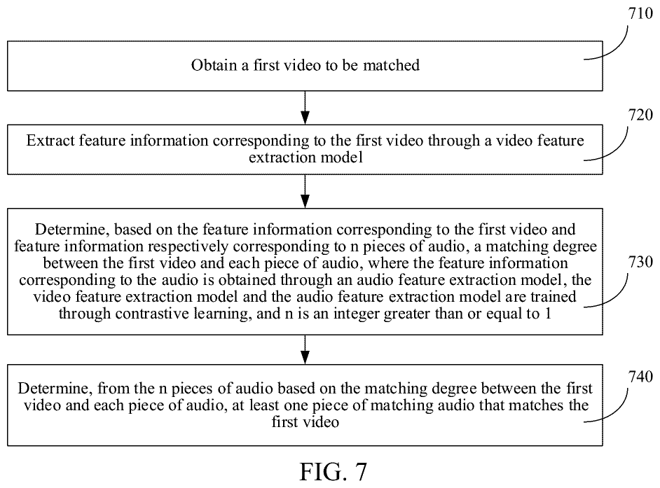

FIG. 7 is a flowchart of an audio/video matching method according to an embodiment of the present disclosure. Operations of the method may be performed by the model use device introduced above. In the following method embodiments, for ease of description, only that each operation is performed by a “computer device” is used for description. The method may include at least one of the following operations (710 to 740):

Operation 710: Obtain a first video to be matched.

In some embodiments, the video to be matched is a video of which a matched audio is not determined. A type of the first video is not limited according to various embodiments of the present disclosure. The first video may be an original video shot by a user account, or may be a video recorded from another video, or the like.

Operation 720: Extract feature information corresponding to the first video through a video feature extraction model.

In some embodiments, the feature information corresponding to the first video is extracted by using the trained video feature extraction model in the foregoing embodiments.

In some embodiments, frame extraction is performed on the first video, to obtain an extracted video frame sequence, and a pixel value matrix corresponding to the extracted video frame sequence is determined. In some embodiments, the pixel value matrix is inputted to the video feature extraction model, to obtain the feature information corresponding to the first video.

In some embodiments, the feature information is a feature vector. In some embodiments, a dimension of the feature information is not limited.

Operation 730: Determine, based on the feature information corresponding to the first video and feature information respectively corresponding to n pieces of audio, a matching degree between the first video and each piece of audio, where the feature information corresponding to the audio is obtained through an audio feature extraction model, the video feature extraction model and the audio feature extraction model are trained through contrastive learning, and n is an integer greater than or equal to 1.

In some embodiments, the n pieces of audio are all audio in the music library and are not filtered. In some embodiments, matching is performing on the first video with all the audio in the music library.

In some other embodiments, the n pieces of audio are audio matching the first video in the music library. In some embodiments, matching is performing on the first video with the audio matching the first audio in the music library.

In some embodiments, the feature information respectively corresponding to the n pieces of audio is extracted through the audio feature extraction model. In some embodiments, the feature information respectively corresponding to the n pieces of audio is extracted through the trained audio feature extraction model in the foregoing embodiments.

In some embodiments, frame extraction is performed on the audio, to obtain an extracted audio frame sequence, and a beat value matrix corresponding to the extracted audio frame sequence is determined. In some embodiments, the beat value matrix is inputted into the audio feature extraction model, to obtain the feature information corresponding to the audio.

Operation 740: Determine, from the n pieces of audio based on the matching degree between the first video and each piece of audio, at least one piece of matching audio that matches the first video.

In some embodiments, at least one piece of matching audio that matches the first video is determined from the n pieces of audio, based on a similarity between the feature information of the first video and the feature information corresponding to each piece of audio. In some embodiments, based on a cosine distance between the feature information corresponding to the video and the feature information corresponding to the audio, the similarity between the feature information of the first video and the feature information corresponding to each piece of audio is determined.

In some embodiments, the at least one piece of matching audio that matches the first video is sorted based on the matching degree, to obtain a recommended audio list. Audio at a position closer to the top of the recommended audio list has a higher matching degree with the first video, and audio at a position closer to the bottom of the recommended audio list has a lower matching degree with the first video.

In the technical solutions provided in the embodiments of the present disclosure, during determining of a piece of audio matching a video to be matched, a pretrained video feature extraction model and audio feature extraction model are used to extract audio and video features. Because the video feature extraction model and the audio feature extraction model are jointly trained through contrastive learning, during joint training, both the video feature extraction model and the audio feature extraction model can learn about features of a video modality and an audio modality, and training is performed through contrastive learning, a feature extraction capability of the video feature extraction model for a video and a feature extraction capability of the audio feature extraction model for audio can be improved. Therefore, the audio recommended to the video to be matched is determined based on a matching degree between audio and video features, so that a background music hit ratio can be improved.

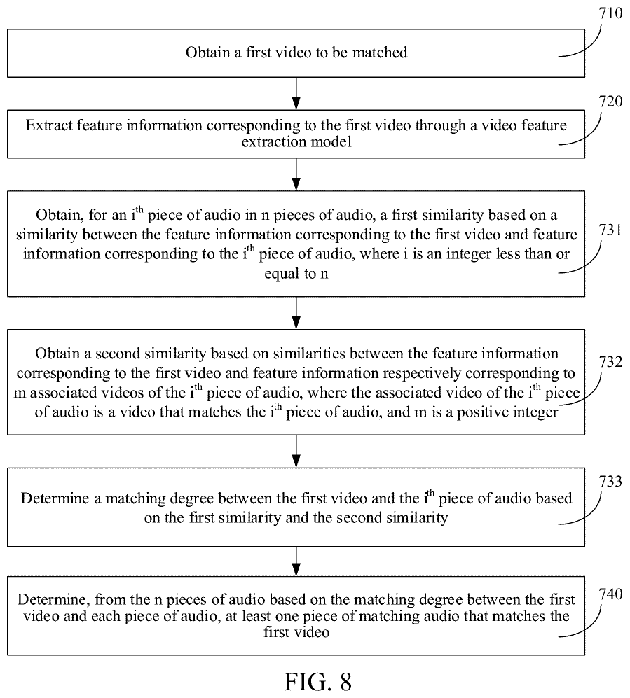

FIG. 8 is a flowchart of an audio/video matching method according to another embodiment of the present disclosure. Operations of the method may be performed by the model use device introduced above. In the following method embodiments, for ease of description, only that each operation is performed by a “computer device” is used for description. The method may include at least one of the following operations (710 to 740):

Operation 710: Obtain a first video to be matched.

In some embodiments, after operation 710, at least one of operation 710-1 and operation 710-2 (not shown in the figure) is further included.

Operation 710-1. Determine a category tag of the first video.

In some embodiments, the category tag of the first video is determined through a video tagging model. In some embodiments, the video tagging model is a machine learning model, for example, a video tagging model trained through active learning. In some embodiments, during training for the video tagging model, an input is a video sample, and an output is a tag corresponding to the video sample. In some embodiments, the video sample is used as a training sample, a manually marked video tag corresponding to the video sample is used as a training tag, and the video tagging model is trained by using a difference between an output tag of the video sample and the manually marked video tag.

In some embodiments, the category tag of the video sample includes at least two types. In some embodiments, one is an emotion type, and the other is a scenario type. In some embodiments, category tags in the emotion type include at least joy, sadness, and the like. In some embodiments, category tags in the scenario type include at least interaction, cartoon, parent-child, and the like. In some embodiments, the category tag is not limited in the present disclosure. In some embodiments, a quantity of category tags corresponding to the video is not limited.

Operation 710-2: Select, from an audio library based on category tags of all pieces of audio included in the audio library, a piece of audio matching the category tag of the first video, to obtain the n pieces of audio.

In some embodiments, each piece of audio also corresponds to an audio tag. In some embodiments, the category tag of the audio is determined through an audio tagging model. In some embodiments, the audio tagging model is a machine learning model, for example, an audio tagging model trained through active learning. In some embodiments, during training for the audio tagging model, an input is an audio sample, and an output is a tag corresponding to the audio sample. In some embodiments, the audio sample is used as a training sample, a manually marked audio tag corresponding to the audio sample is used as a training tag, and the audio tagging model is trained by using a difference between an output tag of the audio sample and the manually marked audio tag.

In some embodiments, the category tag of the audio sample includes at least two types. In some embodiments, one is an emotion type, and the other is a scenario type. In some embodiments, category tags in the emotion type include at least joy, sadness, and the like. In some embodiments, category tags in the scenario type include at least interaction, cartoon, parent-child, and the like. In some embodiments, the category tag is not limited in the present disclosure. In some embodiments, a quantity of category tags corresponding to the audio is not limited.

In some embodiments, when the category tag of the audio is completely consistent with the category tag of the video, the audio is determined as the audio matching the first video.

In some embodiments, when a ratio of a quantity of category tags of audio that are consistent with the category tags of the video to a total quantity of category tags of the video is greater than or equal to a first threshold, the audio is determined as the audio matching the first video.

In some embodiments, determining of the category tag of the audio includes at least one of operation 710-3 to operation 710-5 (not shown in the figure).

Operation 710-3: Obtain first information corresponding to target audio in all the pieces of audio, where the first information includes comment information of the target audio.

In some embodiments, the target audio is any one piece of the audio.

In some embodiments, the first information is the comment information of the target audio. In some embodiments, comment information of the user account for the target audio is collected. Each comment is determined as a piece of first information.

In some embodiments, the first information is name information of an audio list that the target audio is in. In some embodiments, a name of the audio list that the target audio is in is collected.

Operation 710-4: Obtain feature information corresponding to the first information, and classify the feature information, to obtain a classification result.

In some embodiments, inputted first information is classified through a text classification model, to obtain a category tag of audio. In some embodiments, the text classification model is a machine learning model. Because the text classification model is a relatively mature model, details are not described herein.

In some other embodiments, a tag of a video is mapped to audio through a TF-IDF algorithm based on a pairing relationship between a historical audio and the video. Details are not described herein.

Specifically, the feature information corresponding to the first information is extracted, processing such as convolution and pooling is performed, and classification is performed, to obtain classification results and respective corresponding confidences.

In some embodiments, classification targets are various types of words of emotions, such as sadness, joy, and pride. Each emotion is determined as a classification target. In some embodiments, for the feature information corresponding to the first information, there is a corresponding confidence for each classification target.

Operation 710-5: Determine a result that is in the classification result and whose confidence is greater than or equal to a threshold as a category tag of the target audio.

In some embodiments, a result with a highest confidence is determined as the category tag of the target audio. In some embodiments, if a confidence of joy is the highest, joy is determined as the category tag of the target audio.

Operation 720: Extract feature information corresponding to the first video through a video feature extraction model.

Operation 731: Obtain, for the i^{th} piece of audio in the n pieces of audio, a first similarity based on a similarity between the feature information corresponding to the first video and feature information corresponding to the i^{th} piece of audio, where i is an integer less than or equal to n.

In some embodiments, the similarity between the feature information corresponding to the first video and the feature information corresponding to the i^{th} piece of audio is a cosine distance between the feature information corresponding to the first video and the feature information corresponding to the i^{th} piece of audio. In some embodiments, the first similarity may also be referred to as a feature similarity.

Operation 732: Obtain a second similarity based on similarities between the feature information corresponding to the first video and feature information respectively corresponding to m associated videos of the i^{th} piece of audio, where an associated video of the i^{th} piece of audio is a video that matches the i^{th} piece of audio, and m is a positive integer.

In some embodiments, the m associated videos of the i^{th} piece of audio are videos in which the i^{th} piece of audio has been historically used as background music. In some embodiments, the m associated videos of the i^{th} piece of audio may be determined by querying historical data of a publisher.

In some embodiments, operation 732 includes at least one of operation 732-1 and operation 732-2 (not shown in the figure).

Operation 732-1: Respectively determine a similarity between the feature information corresponding to the first video and feature information corresponding to each associated video, to obtain m similarities.

Operation 732-2: Select a largest value from the m similarities as the second similarity.

In some embodiments, the second similarity is determined based on the m similarities. In some embodiments, the second similarity may also be referred to as a user interest similarity (or the foregoing interest similarity).

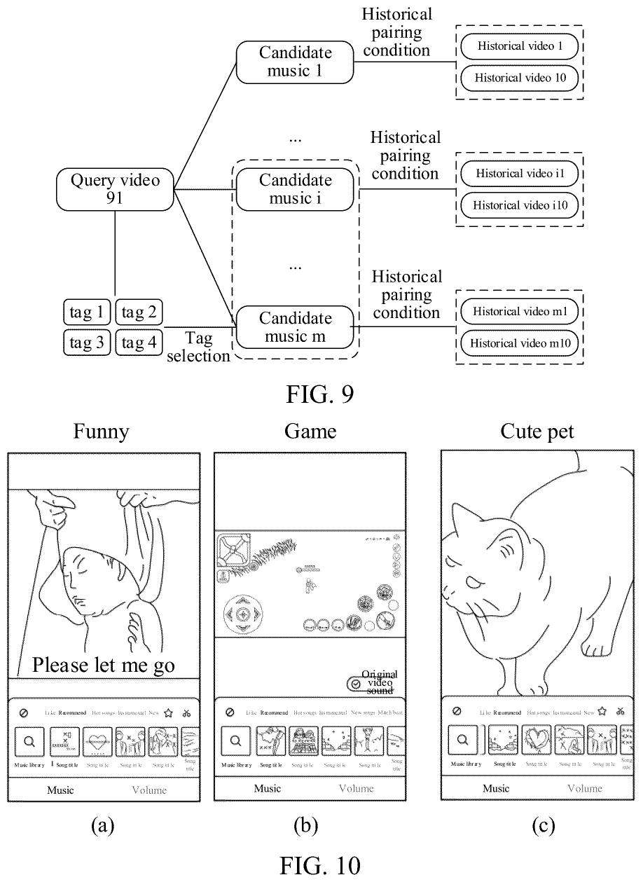

As shown in FIG. 9, based on a query video 91 (the first video to be matched), tags (including a tag 1, a tag 2, a tag 3, and a tag 4) of the query video are determined. In some embodiments, based on the tag 1, the tag 2, the tag 3, and the tag 4, matching audio, for example, candidate music i to candidate music m in the figure, is determined from the music library. In some embodiments, for the candidate music i, based on a historical pairing situation, which may be referred to as historical user data, a historical video i1 and a historical video i10 that once match the candidate music i are determined. In some embodiments, for the candidate music m, based on a historical pairing situation or may be referred to as historical user data, a historical video m1 and a historical video m10 that once match the candidate music m are determined.

Certainly, in the embodiments of the present disclosure, a largest value is selected from the m similarities as the second similarity, so that a video most similar to the first video may be distinguished from the m associated videos. A matching video is selected for the first video based on audio selected for the most similar video, and has a high reference value.

In some embodiments, the m similarities are averaged, to obtain an average similarity as the second similarity.

Operation 733: Determine a matching degree between the first video and the i^{th} piece of audio based on the first similarity and the second similarity.

In some embodiments, weighted summation is performed on the first similarity and the second similarity, to determine the matching degree between the first video and the i^{th} piece of audio.

Operation 740: Determine, from the n pieces of audio based on the matching degree between the first video and each piece of audio, at least one piece of matching audio that matches the first video.

In some embodiments, sim_va=sim_emb+sim_interest, where sim_va represents a matching degree between audio and a video, sim_emb represents a first similarity between the audio and the video, and sim_interest represents a second similarity between the audio and the video.

In some embodiments, the matching degrees between the first video and the audio are sorted in descending order, first K pieces of audio are determined as at least one piece of matching audio that matches the first video, where K is a positive integer. In some embodiments, an audio recommendation list is generated based on the K pieces of audio, for the user to select. In some embodiments, the audio recommendation list is shown in FIG. 10. A sub-figure a is an audio recommendation list for a video category of funny, a sub-figure b is an audio recommendation list for a video category of game, and a sub-figure c is an audio recommendation list for a video category of cute pet.

In some embodiments, a training process of the video feature extraction model and the audio feature extraction model is as follows: constructing a set of sample pairs based on at least one video sample and at least one audio sample, where the set of sample pairs includes at least one positive sample pair and at least one negative sample pair, the positive sample pair includes a video sample and an audio sample that have a matching relationship, and the negative sample pair includes a video sample and an audio sample that do not have a matching relationship; for a video sample and an audio sample in a same sample pair, extracting feature information corresponding to the video sample through a video feature extraction model, and extracting feature information corresponding to the audio sample through an audio feature extraction model; determining a value of a contrastive loss function based on the feature information respectively corresponding to the video sample and the audio sample in the same sample pair, where the contrastive loss function is configured for representing a degree of matching of the sample pair; and adjusting parameters of the video feature extraction model and the audio feature extraction model based on the value of the contrastive loss function, to obtain a trained video feature extraction model and a trained audio feature extraction model.

In some embodiments, for a specific training process of the video feature extraction model and the audio feature extraction model, refer to the foregoing embodiment, and details are not described herein again.

According to the technical solutions provided in the embodiments of the present disclosure, user experience of small world publishers is improved. Through a small traffic experiment, a recommended background music hit rate (+12%) and a proportion of video posted with music (+4%) are both prominent in forward directions. The technical solutions have been applied to a Mobile QQ small world publisher, and good results are achieved in a small world publisher scenario. In addition, quality of a small world video of user generated content (ugc) is improved, and background music promotes emotional expression of the video, to increase attractiveness of the video to audiences.

In addition, in the embodiments of the present disclosure, when a piece of audio matching the first video is determined based on a similarity, in addition to a feature similarity brought by a feature of the audio, an interest similarity brought by user interest (a historical paired video) is further introduced, so that when audio is recommended, the feature of the audio is considered, and an impact of audio recommendation brought by a user historical behavior (the user interest) is further considered. Therefore, it is conducive to improving accuracy of recommended audio and improving an audio hit ratio.

Certainly, because a video is not matched with each piece of audio in the music library, audio with the same category tag is selected for similarity calculation in a next operation, which is conducive to reducing resource overheads caused by determining matching audio.

The following describes apparatus embodiments of the present disclosure, which can be configured for executing the method embodiments of the present disclosure. For details not disclosed in the apparatus embodiments of the present disclosure, refer to the method embodiments of the present disclosure.

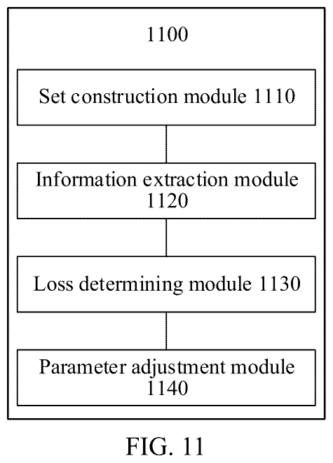

FIG. 11 is a block diagram of a model training apparatus for audio/video matching according to an embodiment of the present disclosure. An apparatus 1100 may include: a set construction module 1110, an information extraction module 1120, a loss determining module 1130, and a parameter adjustment module 1140.

The set construction module 1110 is configured to construct a set of sample pairs based on at least one video sample and at least one audio sample, where the set of sample pairs includes at least one positive sample pair and at least one negative sample pair, the positive sample pair includes a video sample and an audio sample that have a matching relationship, and the negative sample pair includes a video sample and an audio sample that do not have a matching relationship.

The information extraction module 1120 is configured to: for a video sample and an audio sample in a same sample pair, extract feature information corresponding to the video sample through a video feature extraction model, and extract feature information corresponding to the audio sample through an audio feature extraction model.

The loss determining module 1130 is configured to determine a value of a contrastive loss function based on the feature information respectively corresponding to the video sample and the audio sample in the same sample pair, where the contrastive loss function is configured for representing a degree of matching of the sample pair.

The parameter adjustment module 1140 is configured to adjust parameters of the video feature extraction model and the audio feature extraction model based on the value of the contrastive loss function, to obtain a trained video feature extraction model and a trained audio feature extraction model.

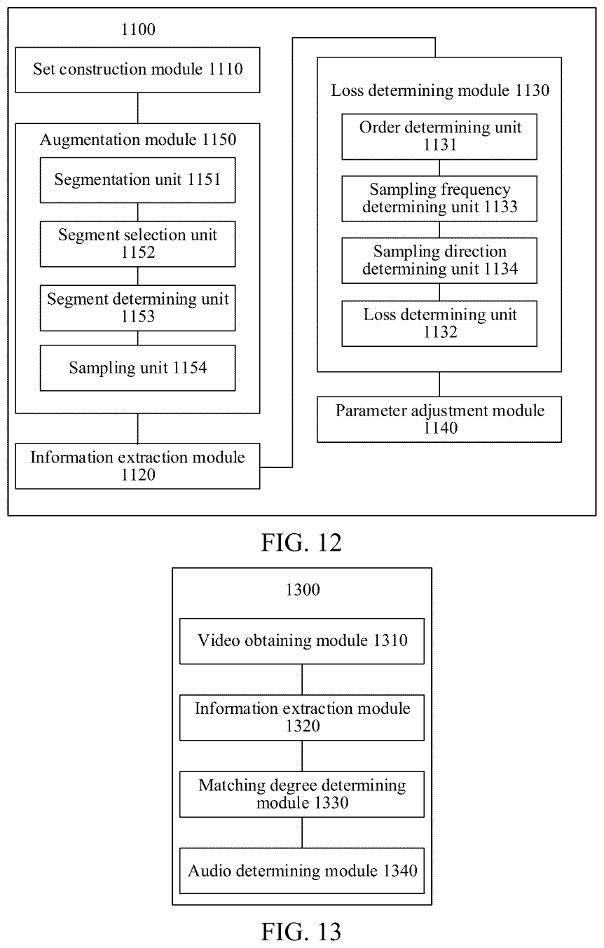

In some embodiments, as shown in FIG. 12, the apparatus further includes an augmentation module 1150.

The augmentation module 1150 is configured to separately perform augmentation processing on a video sample and an audio sample in a same sample pair, to obtain an augmented video sample corresponding to the video sample and an augmented audio sample corresponding to the audio sample.

The information extraction module 1120 is further configured to extract feature information corresponding to the augmented video sample through the video feature extraction model, and extract feature information corresponding to the augmented audio sample through the audio feature extraction model.

The loss determining module 1130 is configured to determine the value of the contrastive loss function based on the video feature information corresponding to the video sample and the audio feature information corresponding to the audio sample in the same sample pair, and the feature information corresponding to the augmented video sample and the feature information corresponding to the augmented audio sample.

In some embodiments, the loss determining module 1130 is configured to determine a first contrastive loss based on the feature information corresponding to the video sample and the feature information corresponding to the augmented video sample.

The loss determining module 1130 is further configured to determine a second contrastive loss based on the feature information corresponding to the video sample and the feature information corresponding to the augmented audio sample.

The loss determining module 1130 is further configured to determine a third contrastive loss based on the feature information corresponding to the augmented video sample and the feature information corresponding to the audio sample.

The loss determining module 1130 is further configured to determine the value of the contrastive loss function based on the first contrastive loss, the second contrastive loss, and the third contrastive loss.

In some embodiments, as shown in FIG. 12, the augmentation module 1150 includes a segmentation unit 1151, a segment selection unit 1152, and a segment determining unit 1153.

The segmentation unit 1151 is configured to: for the sample pair in the set, segment the video sample in the sample pair, to obtain a plurality of video segments, where the feature information corresponding the video sample is feature information corresponding to a first video segment obtained by extracting the first video segment in the plurality of video segments through the video feature extraction model; and the feature information corresponding to the audio sample is feature information corresponding to a first audio segment obtained by extracting the first audio segment through the audio feature extraction model, where the first audio segment is an audio segment corresponding to the first video segment.

The segment selection unit 1152 is configured to select, from the plurality of video segments, a second video segment different from the first video segment as the augmented video sample, where the feature information corresponding to the augmented video sample is feature information corresponding to the second video segment obtained by extracting the second video segment through the video feature extraction model.

The segment determining unit 1153 is configured to determine a second audio segment as the augmented audio sample, where the second audio segment is an audio segment corresponding to the second video segment, and the feature information corresponding to the augmented audio sample is feature information corresponding to the second audio segment obtained by extracting the second audio segment through the audio feature extraction model.

In some embodiments, as shown in FIG. 12, the loss determining module 1130 further includes an order determining unit 1131 and a loss determining unit 1132.

The order determining unit 1131 is configured to determine an order of the first video segment and the second video segment through a first order classifier based on the feature information corresponding to the first video segment and the feature information corresponding to the second video segment.

The order determining unit 1131 is configured to determine an order of the first audio segment and the second audio segment through a second order classifier based on the feature information corresponding to the first audio segment and the feature information corresponding to the second audio segment.

The order determining unit 1131 is configured to determine an order of the second video segment and the second audio segment through a third order classifier based on the feature information corresponding to the second video segment and the feature information corresponding to the second audio segment.

The loss determining unit 1132 is configured to determine an order classification loss based on the orders determined by the first order classifier, the second order classifier, and the third order classifier, where the order classification loss is configured for reflecting prediction accuracy of the orders, and the order classification loss is configured for adjusting a model parameter with reference to the value of the contrastive loss function.

In some embodiments, as shown in FIG. 12, the augmentation module 1150 further includes a sampling unit 1154.

The sampling unit 1154 is configured to select at least one frame from the video sample at a first sampling frequency, to obtain a first extracted video frame sequence, where the feature information corresponding to the video sample is feature information corresponding to the first extracted video frame sequence obtained by extracting the first extracted video frame sequence through the video feature extraction model.

The sampling unit 1154 is further configured to select at least one frame from the video sample at the second sampling frequency, to obtain a second extracted video frame sequence as the augmented video sample, where the feature information corresponding to the augmented video sample is feature information corresponding to the second extracted video frame sequence obtained by extracting the second extracted video frame sequence through the video feature extraction model; and the second sampling frequency is different from the first sampling frequency.

The sampling unit 1154 is configured to select at least one frame from the audio sample at a third sampling frequency, to obtain a first extracted audio frame sequence, where the feature information corresponding to the audio sample is feature information corresponding to the first extracted audio frame sequence obtained by extracting the first extracted audio frame sequence through the audio feature extraction model.

The sampling unit 1154 is further configured to select at least one frame from the audio sample at the fourth sampling frequency, to obtain a second extracted audio frame sequence as the augmented audio sample, where the feature information corresponding to the augmented audio sample is feature information corresponding to the second extracted audio frame sequence obtained by extracting the second extracted audio frame sequence through the audio feature extraction model; and the fourth sampling frequency is different from the third sampling frequency.

In some embodiments, as shown in FIG. 12, the loss determining module 1130 further includes a sampling frequency determining unit 1133.

the sampling frequency determining unit 1133 is configured to determine a predicted sampling frequency of the first extracted video frame sequence through a first speed classifier based on the feature information corresponding to the first extracted video frame sequence, and determine a predicted sampling frequency of the second extracted video frame sequence through the first speed classifier based on the feature information corresponding to the second extracted video frame sequence.

The sampling frequency determining unit 1133 is further configured to determine a predicted sampling frequency of the first extracted audio frame sequence through a second speed classifier based on the feature information corresponding to the first extracted audio frame sequence, and determine a predicted sampling frequency of the second extracted audio frame sequence through the second speed classifier based on the feature information corresponding to the second extracted audio frame sequence.

The loss determining unit 1132 is further configured to determine a speed classification loss based on the predicted sampling frequencies determined by the first speed classifier and the second speed classifier, where the speed classification loss is configured for reflecting prediction accuracy of the sampling frequencies, and the speed classification loss is configured for adjusting a model parameter with reference to the value of the contrastive loss function.

In some embodiments, the sampling unit 1154 is further configured to select at least one frame through sequential sampling of the video sample, to obtain a third extracted video frame sequence, where the feature information corresponding to the video sample in the sample pair is feature information corresponding to the third extracted video frame sequence obtained by extracting the third extracted video frame sequence through the video feature extraction model.

The sampling unit 1154 is further configured to select at least one frame through reverse sampling of the video sample, to obtain a fourth extracted video frame sequence as the augmented video sample, where the feature information corresponding to the augmented video sample is feature information corresponding to the fourth extracted video frame sequence obtained by extracting the fourth extracted video frame sequence through the video feature extraction model.

The sampling unit 1154 is further configured to select at least one frame through sequential sampling of the audio sample, to obtain a third extracted audio frame sequence, where the feature information corresponding to the audio sample is feature information corresponding to the third extracted audio frame sequence obtained by extracting the third extracted audio frame sequence through the audio feature extraction model.

The sampling unit 1154 is further configured to select at least one frame through reverse sampling of the audio sample, to obtain a fourth extracted audio frame sequence as the augmented audio sample, where the feature information corresponding to the augmented audio sample is feature information corresponding to the fourth extracted audio frame sequence obtained by extracting the fourth extracted audio frame sequence through the audio feature extraction model.

In some embodiments, as shown in FIG. 12, the loss determining module 1130 further includes a sampling direction determining unit 1134.

The sampling direction determining unit 1134 is configured to determine a sampling direction of the third extracted video frame sequence through a first direction classifier based on the feature information corresponding to the third extracted video frame sequence, and determine a sampling direction of the fourth extracted video frame sequence through the first direction classifier based on the feature information corresponding to the fourth extracted video frame sequence.

The sampling direction determining unit 1134 is configured to determine a sampling direction of the third extracted audio frame sequence through a second direction classifier based on the feature information corresponding to the third extracted audio frame sequence, and determine a sampling direction of the fourth extracted audio frame sequence through the second direction classifier based on the feature information corresponding to the fourth extracted audio frame sequence.

The loss determining unit 1132 is further configured to determine a direction classification loss based on the sampling directions determined by the first direction classifier and the second direction classifier, where the direction classification loss is configured for reflecting prediction accuracy of the sampling directions, and the direction classification loss is configured for adjusting a model parameter with reference to the value of the contrastive loss function.

FIG. 13 is a block diagram of an audio/video matching apparatus according to an embodiment of the present disclosure. An apparatus 1300 may include: a video obtaining module 1310, an information extraction module 1320, a matching degree determining module 1330, and an audio determining module 1340.

The video obtaining module 1310 is configured to obtain a first video to be matched.

The information extraction module 1320 is configured to extract feature information corresponding to the first video through a video feature extraction model.

The matching degree determining module 1330 is configured to determine, based on the feature information corresponding to the first video and feature information respectively corresponding to n pieces of audio, a matching degree between the first video and each piece of audio, where the feature information corresponding to the audio is obtained through an audio feature extraction model, the video feature extraction model and the audio feature extraction model are trained through contrastive learning, and n is an integer greater than or equal to 1.

The audio determining module 1340 is configured to determine, from the n pieces of audio based on the matching degree between the first video and each piece of audio, at least one piece of matching audio that matches the first video.

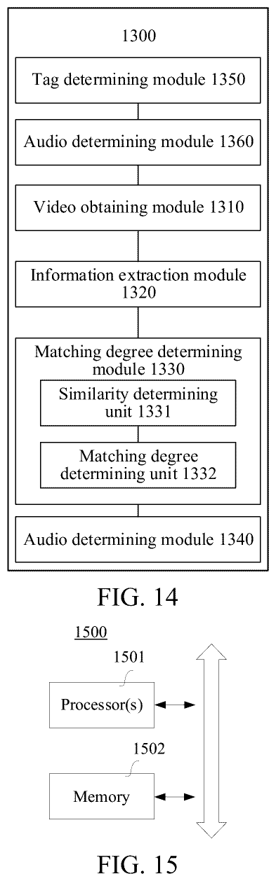

In some embodiments, as shown in FIG. 14, the matching degree determining module 1330 includes a similarity determining unit 1331 and a matching degree determining unit 1332.

The similarity determining unit 1331 is configured to obtain, for the i^{th} piece of audio in the n pieces of audio, a first similarity based on a similarity between the feature information corresponding to the first video and feature information corresponding to the i^{th} piece of audio, where i is an integer less than or equal to n.

The similarity determining unit 1331 is further configured to obtain a second similarity based on similarities between the feature information corresponding to the first video and feature information respectively corresponding to m associated videos of the i^{th} piece of audio, where an associated video of the i^{th} piece of audio is a video that matches the i^{th} piece of audio, and m is a positive integer.

The matching degree determining unit 1332 is configured to determine a matching degree between the first video and the i^{th} piece of audio based on the first similarity and the second similarity.

In some embodiments, the similarity determining unit 1331 is further configured to respectively determine a similarity between the feature information corresponding to the first video and feature information corresponding to each associated video, to obtain m similarities.

The similarity determining unit 1331 is further configured to select a largest value from the m similarities as the second similarity.

In some embodiments, as shown in FIG. 14, the apparatus further includes a tag determining module 1350 and an audio determining module 1360.

The tag determining module 1350 is configured to determine a category tag of the first video.

The audio determining module 1360 is configured to select, from an audio library based on category tags of all pieces of audio included in the audio library, a piece of audio matching the category tag of the first video, to obtain the n pieces of audio.

In some embodiments, the tag determining module 1350 is further configured to obtain first information corresponding to target audio in all the pieces of audio, where the first information includes comment information of the target audio; obtain feature information corresponding to the first information, and classify the feature information, to obtain a classification result; and determine a result that is in the classification result and whose confidence is greater than or equal to a threshold as a category tag of the target audio.

In some embodiments, a training process of the video feature extraction model and the audio feature extraction model is as follows: constructing a set of sample pairs based on at least one video sample and at least one audio sample, where the set of sample pairs includes at least one positive sample pair and at least one negative sample pair, the positive sample pair includes a video sample and an audio sample that have a matching relationship, and the negative sample pair includes a video sample and an audio sample that do not have a matching relationship; for a video sample and an audio sample in a same sample pair, extracting feature information corresponding to the video sample through a video feature extraction model, and extracting feature information corresponding to the audio sample through an audio feature extraction model; determining a value of a contrastive loss function based on the feature information respectively corresponding to the video sample and the audio sample in the same sample pair, where the contrastive loss function is configured for representing a degree of matching of the sample pair; and adjusting parameters of the video feature extraction model and the audio feature extraction model based on the value of the contrastive loss function, to obtain a trained video feature extraction model and a trained audio feature extraction model.

When the apparatuses provided in the foregoing embodiments implement the functions, the division of the foregoing functional modules is merely used as an example for description. In practice, the foregoing functions may be assigned to and completed by different functional modules as required. That is, an internal structure of the device may be divided into different functional modules to complete all or some of the functions described above. In addition, the apparatuses provided in the foregoing embodiments belongs to the same conception as the embodiments of the methods. For a specific implementation process thereof, reference may be made to the method embodiments. Details are not described herein again.

FIG. 15 is a block diagram of a computer device according to another exemplary embodiment of the present disclosure.

An exemplary computer device 1500 includes: processor(s) 1501 and a memory 1502.

The processor 1501 may include one or more processing cores, for example, a 4-core processor or a 15-core processor. The processor 1501 may be implemented in at least one hardware form of a digital signal processor (DSP), a field-programmable gate array (FPGA), and a programmable logic array (PLA). The processor 1501 may alternatively include a main processor and a coprocessor. The main processor is a processor configured to process data in an awake state, and is also referred to as a central processing unit (CPU). The coprocessor is a low power consumption processor configured to process the data in a standby state. In some embodiments, the processor 1501 may be integrated with a graphics processing unit (GPU). The GPU is configured to render and draw content that needs to be displayed on a display screen. In some embodiments, the processor 1501 may further include an AI processor. The AI processor is configured to process computing operations related to machine learning.

The memory 1502 may include one or more computer-readable storage media. The computer-readable storage medium may be tangible and non-transient. The memory 1502 may further include a high-speed random access memory and a non-volatile memory, for example, one or more disk storage devices or flash storage devices. In some embodiments, the non-transient computer-readable storage medium in the memory 1502 has computer-readable instructions stored therein, and the computer-readable instructions are loaded and executed by the processor 1501, to implement the model training method for audio/video matching or the audio/video matching method.

A person skilled in the art may understand that the structure shown in FIG. 15 constitutes no limitation on the computer device 1500, and the computer device may include more or fewer components than those shown in the figure, or some components may be combined, or a different component deployment may be used.

In an exemplary embodiment, a computer-readable storage medium is further provided, having computer-readable instructions stored therein. When the computer-readable instructions are executed by a processor, the method is implemented.

In some embodiments, the computer-readable storage medium may include: a read-only memory (ROM), a random access memory (RAM), a solid state drive (SSD), an optical disc, or the like. The random access memory may include a resistive random access memory (ReRAM) and a dynamic random access memory (DRAM).

In an exemplary embodiment, a computer program product is further provided. The computer program product includes computer-readable instructions, and the computer-readable instructions are stored in a computer-readable storage medium. A processor of the computer device reads the computer-readable instructions from the computer-readable storage medium, and the processor executes the computer-readable instructions, to cause the computer device to perform the model training method for audio/video matching or the audio/video matching method.

“Plurality of” mentioned in the specification means two or more. “And/or” describes an association relationship between associated objects and represents that three relationships may exist. For example, A and/or B may represent the following three cases: Only A exists, both A and B exist, and only B exists. The character “/” in this specification generally indicates an “or” relationship between the associated objects. In addition, the operation numbers described in this specification merely exemplarily show a possible execution sequence of the operations. In some other embodiments, the operations may not be performed according to the number sequence. For example, two operations with different numbers may be performed simultaneously, or two operations with different numbers may be performed according to a sequence contrary to the sequence shown in the figure. This is not limited according to the embodiments of the present disclosure.

Technical features of the foregoing embodiments may be combined in different manners to form other embodiments of the present disclosure. To make description concise, not all possible combinations of the technical features in the foregoing embodiments are described. However, the combinations of these technical features shall be considered as falling within the scope recorded by this specification provided that no conflict exists.

The foregoing embodiments only describe several implementations of the present disclosure, which are described specifically and in detail, but cannot be construed as a limitation to the patent scope of the present disclosure. For a person of ordinary skill in the art, several transformations and improvements can be made without departing from the idea of the present disclosure. These transformations and improvements belong to the protection scope of the present disclosure. Therefore, the protection scope of the patent of the present disclosure shall be subject to the appended claims.

What is claimed is:

1. A model training method for audio/video matching, performed by a computer device, the method comprising:
constructing a set of sample pairs based on at least one video sample and at least one audio sample, the set of sample pairs comprising at least one positive sample pair and at least one negative sample pair, the positive sample pair comprising a video sample and an audio sample that have a matching relationship, and the negative sample pair comprising a video sample and an audio sample that do not have a matching relationship;
for a video sample and an audio sample in a same sample pair, extracting video feature information corresponding to the video sample through a video feature extraction model, and extracting audio feature information corresponding to the audio sample through an audio feature extraction model;
determining a value of a contrastive loss function based on the video feature information and the audio feature information in the same sample pair, the contrastive loss function being configured for representing a degree of matching of the sample pair; and
adjusting parameters of the video feature extraction model and the audio feature extraction model based on the value of the contrastive loss function, to obtain a trained video feature extraction model and a trained audio feature extraction model.

2. The method according to claim 1, further comprising:
separately performing augmentation processing on a video sample and an audio sample in a same sample pair, to obtain an augmented video sample corresponding to the video sample and an augmented audio sample corresponding to the audio sample; and
extracting augmented video feature information corresponding to the augmented video sample through the video feature extraction model, and extracting feature augmented audio information corresponding to the augmented audio sample through the audio feature extraction model; and
determining the value of the contrastive loss function based on the video feature information and the audio feature information comprises:
determining the value of the contrastive loss function based on the video feature information and the audio feature information in the same sample pair, and the augmented video feature information and the augmented audio feature information.

3. The method according to claim 2, wherein determining the value of the contrastive loss function based on the video feature information and the audio feature information in the same sample pair, and the augmented video feature information and the augmented audio feature information comprises:
determining a first contrastive loss based on the video feature information and the augmented video feature information;
determining a second contrastive loss based on the video feature information and the augmented audio feature information;
determining a third contrastive loss based on the augmented video feature information and the audio feature information; and
determining the value of the contrastive loss function based on the first contrastive loss, the second contrastive loss, and the third contrastive loss.

4. The method according to claim 2, wherein separately performing the augmentation processing on the video sample and the audio sample in the same sample pair, to obtain the augmented video sample corresponding to the video sample and the augmented audio sample corresponding to the audio sample comprises:
for the sample pair in the set, segmenting the video sample in the sample pair, to obtain a plurality of video segments, the video feature information corresponding to the video sample in the sample pair being feature information corresponding to a first video segment obtained by extracting the first video segment in the plurality of video segments through the video feature extraction model; and the audio feature information corresponding to the audio sample in the sample pair being feature information corresponding to a first audio segment obtained by extracting the first audio segment through the audio feature extraction model, the first audio segment being an audio segment corresponding to the first video segment;
selecting, from the plurality of video segments, a second video segment different from the first video segment as the augmented video sample, the augmented video feature information corresponding to the augmented video sample being feature information corresponding to the second video segment obtained by extracting the second video segment through the video feature extraction model; and
determining a second audio segment as the augmented audio sample, the second audio segment being an audio segment corresponding to the second video segment, and the augmented audio feature information corresponding to the augmented audio sample being feature information corresponding to the second audio segment obtained by extracting the second audio segment through the audio feature extraction model.

5. The method according to claim 4, further comprising:
determining an order of the first video segment and the second video segment through a first order classifier based on the feature information corresponding to the first video segment and the feature information corresponding to the second video segment;
determining an order of the first audio segment and the second audio segment through a second order classifier based on the feature information corresponding to the first audio segment and the feature information corresponding to the second audio segment;
determining an order of the second video segment and the second audio segment through a third order classifier based on the feature information corresponding to the second video segment and the feature information corresponding to the second audio segment; and
determining an order classification loss based on the orders determined by the first order classifier, the second order classifier, and the third order classifier, the order classification loss being configured for reflecting prediction accuracy of the orders, and the order classification loss being configured for adjusting a model parameter with reference to the value of the contrastive loss function.

6. The method according to claim 2, wherein separately performing the augmentation processing on the video sample and the audio sample in the same sample pair, to obtain the augmented video sample corresponding to the video sample and the augmented audio sample corresponding to the audio sample comprises:
for the sample pair in the set, selecting at least one frame from the video sample in the sample pair at a first sampling frequency, to obtain a first extracted video frame sequence, the video feature information corresponding to the video sample being feature information corresponding to the first extracted video frame sequence obtained by extracting the first extracted video frame sequence through the video feature extraction model;
selecting at least one frame from the video sample in the sample pair at a second sampling frequency, to obtain a second extracted video frame sequence as the augmented video sample, the augmented video feature information corresponding to the augmented video sample being feature information corresponding to the second extracted video frame sequence obtained by extracting the second extracted video frame sequence through the video feature extraction model; and the second sampling frequency being different from the first sampling frequency;
selecting at least one frame from the audio sample in the sample pair at a third sampling frequency, to obtain a first extracted audio frame sequence, the audio feature information corresponding to the audio sample being feature information corresponding to the first extracted audio frame sequence obtained by extracting the first extracted audio frame sequence through the audio feature extraction model; and
selecting at least one frame from the audio sample in the sample pair at a fourth sampling frequency, to obtain a second extracted audio frame sequence as the augmented audio sample, the augmented audio feature information corresponding to the augmented audio sample being feature information corresponding to the second extracted audio frame sequence obtained by extracting the second extracted audio frame sequence through the audio feature extraction model; and the fourth sampling frequency being different from the third sampling frequency.

7. The method according to claim 6, further comprising:
determining a predicted sampling frequency of the first extracted video frame sequence through a first speed classifier based on the feature information corresponding to the first extracted video frame sequence, and determining a predicted sampling frequency of the second extracted video frame sequence through the first speed classifier based on the feature information corresponding to the second extracted video frame sequence;
determining a predicted sampling frequency of the first extracted audio frame sequence through a second speed classifier based on the feature information corresponding to the first extracted audio frame sequence, and determining a predicted sampling frequency of the second extracted audio frame sequence through the second speed classifier based on the feature information corresponding to the second extracted audio frame sequence; and
determining a speed classification loss based on the predicted sampling frequencies determined by the first speed classifier and the second speed classifier, the speed classification loss being configured for reflecting prediction accuracy of the sampling frequencies, and the speed classification loss being configured for adjusting a model parameter with reference to the value of the contrastive loss function.

8. The method according to claim 2, wherein separately performing the augmentation processing on the video sample and the audio sample in the same sample pair, to obtain the augmented video sample corresponding to the video sample and the augmented audio sample corresponding to the audio sample comprises:
for the sample pair in the set, selecting at least one frame through sequential sampling of the video sample in the sample pair, to obtain a third extracted video frame sequence, the video feature information corresponding to the video sample in the sample pair being feature information corresponding to the third extracted video frame sequence obtained by extracting the third extracted video frame sequence through the video feature extraction model;
selecting at least one frame through reverse sampling of the video sample in the sample pair, to obtain a fourth extracted video frame sequence as the augmented video sample, the augmented video feature information corresponding to the augmented video sample being feature information corresponding to the fourth extracted video frame sequence obtained by extracting the fourth extracted video frame sequence through the video feature extraction model;
selecting at least one frame through sequential sampling of the audio sample in the sample pair, to obtain a third extracted audio frame sequence, the audio feature information corresponding to the audio sample being feature information corresponding to the third extracted audio frame sequence obtained by extracting the third extracted audio frame sequence through the audio feature extraction model; and
selecting at least one frame through reverse sampling of the audio sample in the sample pair, to obtain a fourth extracted audio frame sequence as the augmented audio sample, the augmented audio feature information corresponding to the augmented audio sample being feature information corresponding to the fourth extracted audio frame sequence obtained by extracting the fourth extracted audio frame sequence through the audio feature extraction model.

9. The method according to claim 8, further comprising:
determining a sampling direction of the third extracted video frame sequence through a first direction classifier based on the feature information corresponding to the third extracted video frame sequence, and determining a sampling direction of the fourth extracted video frame sequence through the first direction classifier based on the feature information corresponding to the fourth extracted video frame sequence;
determining a sampling direction of the third extracted audio frame sequence through a second direction classifier based on the feature information corresponding to the third extracted audio frame sequence, and determining a sampling direction of the fourth extracted audio frame sequence through the second direction classifier based on the feature information corresponding to the fourth extracted audio frame sequence; and
determining a direction classification loss based on the sampling directions determined by the first direction classifier and the second direction classifier, the direction classification loss being configured for reflecting prediction accuracy of the sampling directions, and the direction classification loss being configured for adjusting a model parameter with reference to the value of the contrastive loss function.

10. A computer device, comprising one or more processors and a memory containing computer-readable instructions that, when being executed, cause the one or more processors to perform:
constructing a set of sample pairs based on at least one video sample and at least one audio sample, the set of sample pairs comprising at least one positive sample pair and at least one negative sample pair, the positive sample pair comprising a video sample and an audio sample that have a matching relationship, and the negative sample pair comprising a video sample and an audio sample that do not have a matching relationship;
for a video sample and an audio sample in a same sample pair, extracting video feature information corresponding to the video sample through a video feature extraction model, and extracting audio feature information corresponding to the audio sample through an audio feature extraction model;
determining a value of a contrastive loss function based on the video feature information and the audio feature information in the same sample pair, the contrastive loss function being configured for representing a degree of matching of the sample pair; and
adjusting parameters of the video feature extraction model and the audio feature extraction model based on the value of the contrastive loss function, to obtain a trained video feature extraction model and a trained audio feature extraction model.

11. The device according to claim 10, wherein the one or more processors are further configured to perform:
separately performing augmentation processing on a video sample and an audio sample in a same sample pair, to obtain an augmented video sample corresponding to the video sample and an augmented audio sample corresponding to the audio sample; and
extracting augmented video feature information corresponding to the augmented video sample through the video feature extraction model, and extracting feature augmented audio information corresponding to the augmented audio sample through the audio feature extraction model; and
determining the value of the contrastive loss function based on the video feature information and the audio feature information comprises:
determining the value of the contrastive loss function based on the video feature information and the audio feature information in the same sample pair, and the augmented video feature information and the augmented audio feature information.

12. The device according to claim 11, wherein the one or more processors are further configured to perform:
determining a first contrastive loss based on the video feature information and the augmented video feature information;
determining a second contrastive loss based on the video feature information and the augmented audio feature information;
determining a third contrastive loss based on the augmented video feature information and the audio feature information; and
determining the value of the contrastive loss function based on the first contrastive loss, the second contrastive loss, and the third contrastive loss.

13. The device according to claim 11, wherein the one or more processors are further configured to perform:
for the sample pair in the set, segmenting the video sample in the sample pair, to obtain a plurality of video segments, the video feature information corresponding to the video sample in the sample pair being feature information corresponding to a first video segment obtained by extracting the first video segment in the plurality of video segments through the video feature extraction model; and the audio feature information corresponding to the audio sample in the sample pair being feature information corresponding to a first audio segment obtained by extracting the first audio segment through the audio feature extraction model, the first audio segment being an audio segment corresponding to the first video segment;
selecting, from the plurality of video segments, a second video segment different from the first video segment as the augmented video sample, the augmented video feature information corresponding to the augmented video sample being feature information corresponding to the second video segment obtained by extracting the second video segment through the video feature extraction model; and
determining a second audio segment as the augmented audio sample, the second audio segment being an audio segment corresponding to the second video segment, and the augmented audio feature information corresponding to the augmented audio sample being feature information corresponding to the second audio segment obtained by extracting the second audio segment through the audio feature extraction model.

14. The device according to claim 13, wherein the one or more processors are further configured to perform:
determining an order of the first video segment and the second video segment through a first order classifier based on the feature information corresponding to the first video segment and the feature information corresponding to the second video segment;
determining an order of the first audio segment and the second audio segment through a second order classifier based on the feature information corresponding to the first audio segment and the feature information corresponding to the second audio segment;
determining an order of the second video segment and the second audio segment through a third order classifier based on the feature information corresponding to the second video segment and the feature information corresponding to the second audio segment; and
determining an order classification loss based on the orders determined by the first order classifier, the second order classifier, and the third order classifier, the order classification loss being configured for reflecting prediction accuracy of the orders, and the order classification loss being configured for adjusting a model parameter with reference to the value of the contrastive loss function.

15. The device according to claim 11, wherein the one or more processors are further configured to perform:
for the sample pair in the set, selecting at least one frame from the video sample in the sample pair at a first sampling frequency, to obtain a first extracted video frame sequence, the video feature information corresponding to the video sample being feature information corresponding to the first extracted video frame sequence obtained by extracting the first extracted video frame sequence through the video feature extraction model;
selecting at least one frame from the video sample in the sample pair at a second sampling frequency, to obtain a second extracted video frame sequence as the augmented video sample, the augmented video feature information corresponding to the augmented video sample being feature information corresponding to the second extracted video frame sequence obtained by extracting the second extracted video frame sequence through the video feature extraction model; and the second sampling frequency being different from the first sampling frequency;
selecting at least one frame from the audio sample in the sample pair at a third sampling frequency, to obtain a first extracted audio frame sequence, the audio feature information corresponding to the audio sample being feature information corresponding to the first extracted audio frame sequence obtained by extracting the first extracted audio frame sequence through the audio feature extraction model; and
selecting at least one frame from the audio sample in the sample pair at a fourth sampling frequency, to obtain a second extracted audio frame sequence as the augmented audio sample, the augmented audio feature information corresponding to the augmented audio sample being feature information corresponding to the second extracted audio frame sequence obtained by extracting the second extracted audio frame sequence through the audio feature extraction model; and the fourth sampling frequency being different from the third sampling frequency.

16. The device according to claim 15, wherein the one or more processors are further configured to perform:
determining a predicted sampling frequency of the first extracted video frame sequence through a first speed classifier based on the feature information corresponding to the first extracted video frame sequence, and determining a predicted sampling frequency of the second extracted video frame sequence through the first speed classifier based on the feature information corresponding to the second extracted video frame sequence;
determining a predicted sampling frequency of the first extracted audio frame sequence through a second speed classifier based on the feature information corresponding to the first extracted audio frame sequence, and determining a predicted sampling frequency of the second extracted audio frame sequence through the second speed classifier based on the feature information corresponding to the second extracted audio frame sequence; and
determining a speed classification loss based on the predicted sampling frequencies determined by the first speed classifier and the second speed classifier, the speed classification loss being configured for reflecting prediction accuracy of the sampling frequencies, and the speed classification loss being configured for adjusting a model parameter with reference to the value of the contrastive loss function.

17. The device according to claim 11, wherein the one or more processors are further configured to perform:
for the sample pair in the set, selecting at least one frame through sequential sampling of the video sample in the sample pair, to obtain a third extracted video frame sequence, the video feature information corresponding to the video sample in the sample pair being feature information corresponding to the third extracted video frame sequence obtained by extracting the third extracted video frame sequence through the video feature extraction model;
selecting at least one frame through reverse sampling of the video sample in the sample pair, to obtain a fourth extracted video frame sequence as the augmented video sample, the augmented video feature information corresponding to the augmented video sample being feature information corresponding to the fourth extracted video frame sequence obtained by extracting the fourth extracted video frame sequence through the video feature extraction model;
selecting at least one frame through sequential sampling of the audio sample in the sample pair, to obtain a third extracted audio frame sequence, the audio feature information corresponding to the audio sample being feature information corresponding to the third extracted audio frame sequence obtained by extracting the third extracted audio frame sequence through the audio feature extraction model; and
selecting at least one frame through reverse sampling of the audio sample in the sample pair, to obtain a fourth extracted audio frame sequence as the augmented audio sample, the augmented audio feature information corresponding to the augmented audio sample being feature information corresponding to the fourth extracted audio frame sequence obtained by extracting the fourth extracted audio frame sequence through the audio feature extraction model.

18. The device according to claim 17, wherein the one or more processors are further configured to perform:
determining a sampling direction of the third extracted video frame sequence through a first direction classifier based on the feature information corresponding to the third extracted video frame sequence, and determining a sampling direction of the fourth extracted video frame sequence through the first direction classifier based on the feature information corresponding to the fourth extracted video frame sequence;
determining a sampling direction of the third extracted audio frame sequence through a second direction classifier based on the feature information corresponding to the third extracted audio frame sequence, and determining a sampling direction of the fourth extracted audio frame sequence through the second direction classifier based on the feature information corresponding to the fourth extracted audio frame sequence; and
determining a direction classification loss based on the sampling directions determined by the first direction classifier and the second direction classifier, the direction classification loss being configured for reflecting prediction accuracy of the sampling directions, and the direction classification loss being configured for adjusting a model parameter with reference to the value of the contrastive loss function.

19. A non-transitory computer readable storage medium containing computer-readable instructions that, when being executed, cause at least one processor to perform:
constructing a set of sample pairs based on at least one video sample and at least one audio sample, the set of sample pairs comprising at least one positive sample pair and at least one negative sample pair, the positive sample pair comprising a video sample and an audio sample that have a matching relationship, and the negative sample pair comprising a video sample and an audio sample that do not have a matching relationship;
for a video sample and an audio sample in a same sample pair, extracting video feature information corresponding to the video sample through a video feature extraction model, and extracting audio feature information corresponding to the audio sample through an audio feature extraction model;
determining a value of a contrastive loss function based on the video feature information and the audio feature information in the same sample pair, the contrastive loss function being configured for representing a degree of matching of the sample pair; and
adjusting parameters of the video feature extraction model and the audio feature extraction model based on the value of the contrastive loss function, to obtain a trained video feature extraction model and a trained audio feature extraction model.

20. The storage medium according to claim 19, wherein the at least one processor is further configured to perform:
separately performing augmentation processing on a video sample and an audio sample in a same sample pair, to obtain an augmented video sample corresponding to the video sample and an augmented audio sample corresponding to the audio sample; and
extracting augmented video feature information corresponding to the augmented video sample through the video feature extraction model, and extracting feature augmented audio information corresponding to the augmented audio sample through the audio feature extraction model; and
determining the value of the contrastive loss function based on the video feature information and the audio feature information comprises:
determining the value of the contrastive loss function based on the video feature information and the audio feature information in the same sample pair, and the augmented video feature information and the augmented audio feature information.
